(19) United States
(12) Patent Application Publication
(10) Pub. No.: US 2024/0031939 A1
(43) Pub. Date: Jan. 25, 2024

(54) METHOD FOR DETERMINING TRANSMISSION POWER OF UPLINK SIGNAL BY TERMINAL IN WIRELESS COMMUNICATION SYSTEM AND DEVICE THEREFOR

(71) Applicant: LG Electronics Inc., Seoul (KR)

(72) Inventors: Haewook PARK, Seoul (KR); Suckchel YANG, Seoul (KR); Kijun KIM, Seoul (KR); Hyunsu CHA, Seoul (KR)

(21) Appl. No.: 18/040,921

(22) PCT Filed: Aug. 6, 2021
(86) PCT No.: PCT/KR2021/010417

§ 371 Date: Feb. 7, 2023

(30) Foreign Application Priority Data
Aug. 7, 2020 (KR) 10-2020-0099149

(51) Int. Cl. H04W 52/14; H04W 52/54

(52) U.S. Cl. CPC H04W 52/146; H04W 52/54; H04W 84/06

(57) ABSTRACT

Various embodiments provide a method for determining transmission power of an uplink signal by a terminal in a wireless communication system and a device therefor. Disclosed are a method and a device, the method comprising the steps of: receiving configuration information including information related to multiple power control settings from a non-terrestrial network (NTN); and determining the transmission power of the uplink signal on the basis of the multiple power control settings, wherein the terminal determines a first power control setting among the multiple power control settings on the basis of satellite orbit information related to the NTN, and determines the transmission power on the basis of the first power control setting.

### TECHNICAL FIELD

The present disclosure relates to a method of determining transmission power for an uplink (UL) signal based on a plurality of power control settings received from a non-terrestrial network (NTN) by a user equipment (UE) in a wireless communication system, and a device therefor.

### BACKGROUND ART

Wireless communication systems have been widely deployed to provide various types of communication services such as voice or data. In general, a wireless communication system is a multiple access system that supports communication of multiple users by sharing available system resources (a bandwidth, transmission power, etc.). Examples of multiple access systems include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multi carrier frequency division multiple access (MC-FDMA) system.

As more and more communication devices require larger communication capacities in transmitting and receiving signals, there is a need for mobile broadband communication improved from the legacy radio access technology. Accordingly, communication systems considering services/UEs sensitive to reliability and latency are under discussion. A next-generation radio access technology in consideration of enhanced mobile broadband communication, massive Machine Type Communication (MTC), and Ultra-Reliable and Low Latency Communication (URLLC) may be referred to as new radio access technology (RAT) or new radio (NR).

### DISCLOSURE

### Technical Problem

An objective of the present disclosure is to provide a method and device for overcoming inefficiency of power control due to a delay in an NTN through power control based on a plurality of power control settings and satellite orbit information, which is sequentially applied in response to a change in satellite location.

It will be appreciated by those of ordinary skill in the art to which the embodiment(s) pertain that the objects that could be achieved with the embodiment(s) are not limited to what has been particularly described hereinabove and the above and other objects will be more clearly understood from the following detailed description.

### Technical Solution

According to an aspect, a method of determining transmission power of an uplink (UL) signal by a user equipment (UE) in a wireless communication system includes receiving configuration information including information related to a plurality of power control settings from a non-terrestrial network (NTN); and determining the transmission power of the UL signal based on the plurality of power control settings, wherein the UE determines a first power control setting among the plurality of power control settings based on satellite orbit information related to the NTN and determines the transmission power based on the first power control setting.

The configuration information may further include the satellite orbit information and information on locations of a plat form related to the NTN corresponding to the plurality of power control settings.

The first power control setting may be determined as a power control setting corresponding to the location of the platform related to the NTN estimated based on the satellite orbit information among the plurality of power control settings.

The UE may determine whether to change the first power control setting to the second power control setting among the plurality of power control settings based on a change of the platform related to the NTN.

The configuration information may further include information on satellite orbit ranges corresponding to the plurality of power control settings.

The UE may determine a satellite orbit range corresponding to the platform related to the NTN among the satellite orbit ranges based on the satellite orbit information, and the first power control setting may be determined as a power control setting corresponding to the satellite orbit range among the plurality of power control settings.

When a satellite orbit range corresponding to the platform related to the NTN is changed, the first power control setting is changed to a second power control setting corresponding to the changed satellite orbit range, and the transmission power is determined based on the second power control setting.

The configuration information further includes information on times at which each of the plurality of power control settings is sequentially applied.

The plurality of power control settings are pre-mapped to a plurality of BWP indexes, and the UE performs BWP switching with a BWP index corresponding to the first power control setting.

According to another aspect, a method of controlling transmission power of a user equipment (UE) by a non-terrestrial network (NTN) in a wireless communication system includes determining a plurality of power control settings based on satellite orbit information related to the NTN, and transmitting configuration information on the plurality of power control settings to the UE, wherein location information on the corresponding NTN is pre-configured for each of the plurality of power control settings.

The configuration information further includes information on satellite orbit ranges corresponding to the plurality of power control settings, respectively.

According to another aspect, a user equipment (UE) for determining transmission power of an uplink (UL) signal in a wireless communication system includes a radio frequency (RF) transceiver, and a processor connected to the RF transceiver, wherein the processor controls the RF transceiver to receive configuration information including information related to a plurality of power control settings from a non-terrestrial network (NTN), to determine a first power control setting among the plurality of power control settings based on satellite orbit information related to the NTN, and to determine the power transmission based on the first power control setting.

According to another aspect, a non-terrestrial network (NTN) for controlling transmission power by a user equipment (UE) in a wireless communication system includes a radio frequency (RF) transceiver, and a processor connected to the RF transceiver, wherein the processor determines a plurality of power control settings based on satellite orbit information related to the NTN, and controls the RF transceiver to transmit configuration information on the plurality of power control settings to the UE, and location information on the corresponding NTN is pre-configured for each of the plurality of power control settings.

According to another aspect, a chip set for determining transmission power of an uplink (UL) signal in a wireless communication system includes at least one processor, and at least one memory operatively connected to the at least one processor and configured to cause the at least one processor to perform an operation when being executed, wherein the operation includes receiving configuration information including information related to a plurality of power control settings from a non-terrestrial network (NTN), determining a first power control setting among the plurality of power control settings based on satellite orbit information related to the NTN, and determining the power transmission based on the first power control setting.

According to another aspect, a computer readable storage medium including at least one computer program for performing an operation for determining transmission power of an uplink (UL) signal in a wireless communication system includes at least one computer program that causes the at least one processor to perform an operation for determining the transmission power, and a computer readable storage medium that stores the at least one computer program, wherein the operation includes receiving configuration information including information related to a plurality of power control settings from a non-terrestrial network (NTN), determining a first power control setting among the plurality of power control settings based on satellite orbit information related to the NTN, and determining the power transmission based on the first power control setting.

### ADVANTAGEOUS EFFECTS

Various embodiments may overcome inefficiency of power control due to a delay in an NTN through power control based on a plurality of power control settings and satellite orbit information, which is sequentially applied in response to a change in satellite location.

Effects to be achieved by embodiment(s) are not limited to what has been particularly described hereinabove and other effects not mentioned herein will be more clearly understood by persons skilled in the art to which embodiment(s) pertain from the following detailed description.

### DESCRIPTION OF DRAWINGS

The accompanying drawings, which are included to provide a further understanding of the disclosure and are incorporated in and constitute a part of this application, illustrate embodiments of the disclosure and together with the description serve to explain the principle of the disclosure.

FIG. 1 illustrates the structure of an LTE system to which embodiment(s) are applicable.

FIG. 2 illustrates the structure of an NR system to which embodiment(s) are applicable.

FIG. 3 illustrates the structure of an NR radio frame to which embodiment(s) are applicable.

FIG. 4 illustrates the slot structure of an NR frame to which embodiment(s) are applicable.

FIG. 5 illustrates a procedure in which a base station transmits a downlink signal to a UE.

FIG. 6 illustrates a procedure in which a UE transmits an uplink signal to a base station.

FIG. 7 shows an example of a UL BM procedure using a SRS.

FIG. 8 shows an example of a procedure for controlling uplink transmit power.

FIG. 9 illustrates a non-terrestrial network (NTN).

FIG. 10 illustrates an overview and a scenario of an NTN.

FIG. 11 illustrates TA components of the NTN.

FIG. 12 is a flowchart illustrating a method for a UE to perform a UL transmission operation based on embodiments.

FIG. 13 is a flowchart illustrating a method for a UE to perform a DL reception operation based on embodiments.

FIG. 14 is a flowchart illustrating a method for a BS to perform a UL reception operation based on embodiments.

FIG. 15 is a diagram for explaining a method of performing a DL transmission operation by a base station based on the above-described embodiments.

FIGS. 16 and 17 are flowcharts illustrating methods of performing signaling between a BS and a UE based on embodiments.

FIG. 18 is a diagram for explaining a method of receiving a PDSCH from an NTN by a UE.

FIG. 19 is a diagram for explaining a method of transmitting a PDSCH to a UE by an NTN.

FIG. 20 illustrates a communication system applied to the present disclosure.

FIG. 21 illustrates wireless devices applicable to the present disclosure.

FIG. 22 illustrates another example of a wireless device to which the present disclosure is applied.

### BEST MODE

The wireless communication system is a multiple access system that supports communication with multiple users by sharing available system resources (e.g., bandwidth, transmission power, etc.). Examples of the multiple access system include a code division multiple access (CDMA) system, a frequency division multiple access (FDMA) system, a time division multiple access (TDMA) system, an orthogonal frequency division multiple access (OFDMA) system, a single carrier frequency (SC-FDMA) system, a multi carrier frequency division multiple access (MC-FDMA) system, and the like.

A sidelink refers to a communication scheme in which a direct link is established between user equipments (UEs) to directly exchange voice or data between UEs without assistance from a base station (BS). The sidelink is being considered as one way to address the burden on the BS caused by rapidly increasing data traffic.

Vehicle-to-everything (V2X) refers to a communication technology for exchanging information with other vehicles, pedestrians, and infrastructure-built objects through wired/wireless communication. V2X may be divided into four types: vehicle-to-vehicle (V2V), vehicle-to-infrastructure (V2I), vehicle-to-network (V2N), and vehicle-to-pedestrian (V2P). V2X communication may be provided through a PC5 interface and/or a Uu interface.

As more and more communication devices require larger communication capacities in transmitting and receiving signals, there is a need for mobile broadband communication improved from the legacy radio access technology. Accordingly, communication systems considering services/UEs sensitive to reliability and latency are under discussion. A next-generation radio access technology in consideration of enhanced mobile broadband communication, massive MTC, and Ultra-Reliable and Low Latency Communication (URLLC) may be referred to as new radio access technology (RAT) or new radio (NR). Even in NR, V2X communication may be supported.

Techniques described herein may be used in various wireless access systems such as code division multiple access (CDMA), frequency division multiple access (FDMA), time division multiple access (TDMA), orthogonal frequency division multiple access (OFDMA), single carrier-frequency division multiple access (SC-FDMA), etc. CDMA may be implemented as a radio technology such as universal terrestrial radio access (UTRA) or CDMA2000. TDMA may be implemented as a radio technology such as global system for mobile communications (GSM)/general packet radio service (GPRS)/Enhanced Data Rates for GSM Evolution (EDGE). OFDMA may be implemented as a radio technology such as IEEE 802.11 (Wi-Fi), IEEE 802.16 (WiMAX), IEEE 802.20, evolved-UTRA (E-UTRA) etc. UTRA is a part of universal mobile telecommunications system (UMTS). 3GPP LTE is a part of Evolved UMTS (E-UMTS) using E-UTRA. 3GPP LTE employs OFDMA for downlink and SC-FDMA for uplink. LTE-A is an evolution of 3GPP LTE. 3GPP NR (New Radio or New Radio Access Technology) is an evolved version of 3GPP LTE/LTE-A/LTE-A pro.

5G NR is a successor technology of LTE-A, and is a new clean-slate mobile communication system with characteristics such as high performance, low latency, and high availability. 5G NR may utilize all available spectrum resources, from low frequency bands below 1 GHz to intermediate frequency bands from 1 GHz to 10 GHz and high frequency (millimeter wave) bands above 24 GHz.

For clarity of explanation, LTE-A or 5G NR is mainly described, but the technical spirit of the embodiment(s) is not limited thereto

[symbol]

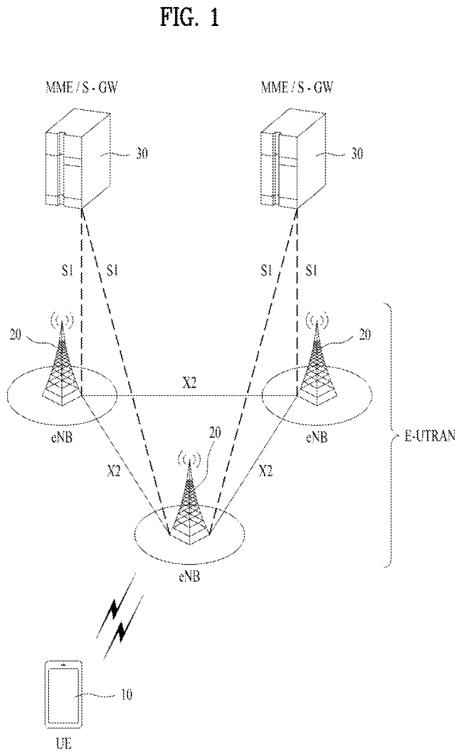

FIG. 1 illustrates the structure of an LTE system to which the present disclosure is applicable. This may also be called an evolved UMTS terrestrial radio access network (E-UTRAN) or LTE/LTE-A system.

Referring to FIG. 1, the E-UTRAN includes evolved Node Bs (eNBs) 20 which provide a control plane and a user plane to UEs 10. A UE 10 may be fixed or mobile, and may also be referred to as a mobile station (MS), user terminal (UT), subscriber station (SS), mobile terminal (MT), or wireless device. An eNB 20 is a fixed station communication with the UE 10 and may also be referred to as a base station (BS), a base transceiver system (BTS), or an access point.

eNBs 20 may be connected to each other via an X2 interface. An eNB 20 is connected to an evolved packet core (EPC) 39 via an S1 interface. More specifically, the eNB 20 is connected to a mobility management entity (MME) via an S1-MME interface and to a serving gateway (S-GW) via an S1-U interface.

The EPC 30 includes an MME, an S-GW, and a packet data network-gateway (P-GW). The MME has access information or capability information about UEs, which are mainly used for mobility management of the UEs. The S-GW is a gateway having the E-UTRAN as an end point, and the P-GW is a gateway having a packet data network (PDN) as an end point.

Based on the lowest three layers of the open system interconnection (OSI) reference model known in communication systems, the radio protocol stack between a UE and a network may be divided into Layer 1 (L1), Layer 2 (L2) and Layer 3 (L3). These layers are defined in pairs between a UE and an Evolved UTRAN (E-UTRAN), for data transmission via the Uu interface. The physical (PHY) layer at Ll provides an information transfer service on physical channels. The radio resource control (RRC) layer at L3 functions to control radio resources between the UE and the network. For this purpose, the RRC layer exchanges RRC messages between the UE and an eNB.

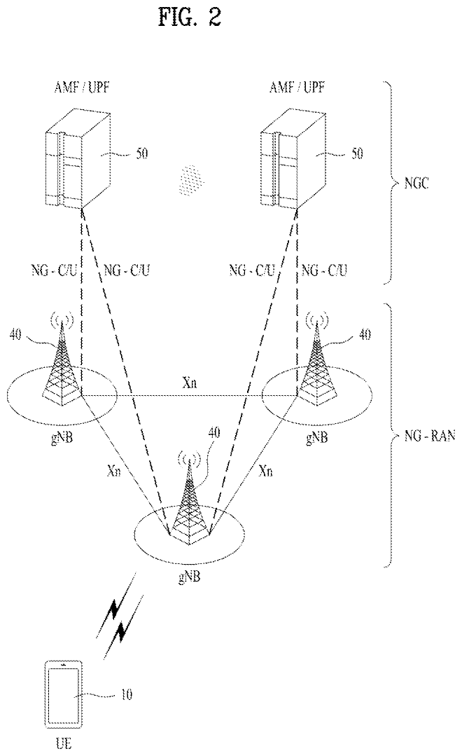

FIG. 2 illustrates the structure of a NR system to which the present disclosure is applicable.

Referring to FIG. 2, a next generation radio access network (NG-RAN) may include a next generation Node B (gNB) and/or an eNB, which provides user-plane and control-plane protocol termination to a UE. In FIG. 2, the NG-RAN is shown as including only gNBs, by way of example. A gNB and an eNB are connected to each other via an Xn interface. The gNB and the eNB are connected to a 5G core network (5GC) via an NG interface. More specifically, the gNB and the eNB are connected to an access and mobility management function (AMF) via an NG-C interface and to a user plane function (UPF) via an NG-U interface.

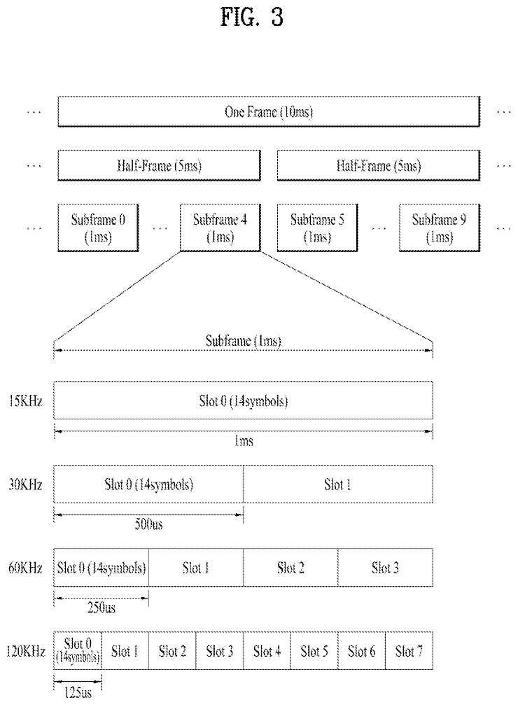

FIG. 3 illustrates the structure of a NR radio frame to which the present disclosure is applicable.

Referring to FIG. 3, a radio frame may be used for UL transmission and DL transmission in NR. A radio frame is 10 ms in length, and may be defined by two 5-ms half-frames. An HF may include five 1-ms subframes. A subframe may be divided into one or more slots, and the number of slots in an SF may be determined according to a subcarrier spacing (SCS). Each slot may include 12 or 14 OFDM(A) symbols according to a cyclic prefix (CP).

In a normal CP (NCP) case, each slot may include 14 symbols, whereas in an extended CP (ECP) case, each slot may include 12 symbols. Herein, a symbol may be an OFDM symbol (or CP-OFDM symbol) or an SC-FDMA symbol (or DFT-s-OFDM symbol).

Table 1 below lists the number of symbols per slot N^{slot}_{symb}, the number of slots per frame N^{frame,u}ₛₗₒₜ, and the number of slots per subframe N^{subframe,u}ₛₗₒₜ according to an SCS configuration μ in the NCP case.

TABLE 1

| SCS (15*2u) | N^{slot}_{symb} | N^{frame, u}ₛₗₒₜ | N^{subframe, u}ₛₗₒₜ |
|---|---|---|---|
| 15 KHz (u = 0) | 14 | 10 | 1 |
| 30 KHz (u = 1) | 14 | 20 | 2 |
| 60 KHz (u = 2) | 14 | 40 | 4 |
| 120 KHz (u = 3) | 14 | 80 | 8 |
| 240 KHz (u = 4) | 14 | 160 | 16 |

Table 2 below lists the number of symbols per slot, the number of slots per frame, and the number of slots per subframe according to an SCS in the ECP case.

TABLE 2

| SCS (15*2\hat{ }u) | N^{slot}_{symb} | N^{frame, u}ₛₗₒₜ | N^{subframe, u}ₛₗₒₜ |
|---|---|---|---|
| 60 KHz (u = 2) | 12 | 40 | 4 |

In the NR system, different OFDM(A) numerologies (e.g., SCSs, CP lengths, etc.) may be configured for a plurality of cells aggregated for one UE. Thus, the (absolute) duration of a time resource (e.g., SF, slot, or TTI) including the same number of symbols may differ between the aggregated cells (such a time resource is commonly referred to as a time unit (TU) for convenience of description).

In NR, multiple numerologies or SCSs to support various 5G services may be supported. For example, a wide area in conventional cellular bands may be supported when the SCS is 15 kHz, and a dense urban environment, lower latency, and a wider carrier bandwidth may be supported when the SCS is 30 kHz/60 kHz. When the SCS is 60 kHz or higher, a bandwidth wider than 24.25 GHz may be supported to overcome phase noise.

The NR frequency band may be defined as two types of frequency ranges. The two types of frequency ranges may be FR1 and FR2. The numerical values of the frequency ranges may be changed. For example, the two types of frequency ranges may be configured as shown in Table 3 below. Among the frequency ranges used in the NR system, FR1 may represent “sub 6 GHz range” and FR2 may represent “above 6 GHz range” and may be called millimeter wave (mmW).

TABLE 3

| Frequency Range | Corresponding | Subcarrier |
|---|---|---|
| designation | frequency range | Spacing (SCS) |
| FR1 | 450 MHz-6000 MHz | 15, 30, 60 kHz |
| FR2 | 24250 MHz-52600 MHz | 60, 120, 240 kHz |

As mentioned above, the numerical values of the frequency ranges of the NR system may be changed. For example, FR1 may include a band of 410 MHz to 7125 MHz as shown in Table 4 below. That is, FR1 may include a frequency band of 6 GHz (or 5850 MHz, 5900 MHz, 5925 MHz, etc.) or higher. For example, the frequency band of 6 GHz (or 5850 MHz, 5900 MHz, 5925 MHz, etc.) or higher included in FR1 may include an unlicensed band. The unlicensed band may be used for various purposes, for example, for communication for vehicles (e.g., autonomous driving).

TABLE 4

| Frequency Range | Corresponding | Subcarrier |
|---|---|---|
| designation | frequency range | Spacing (SCS) |
| FR1 | 410 MHz-7125 MHz | 15, 30, 60 kHz |
| FR2 | 24250 MHz-52600 MHz | 60, 120, 240 kHz |

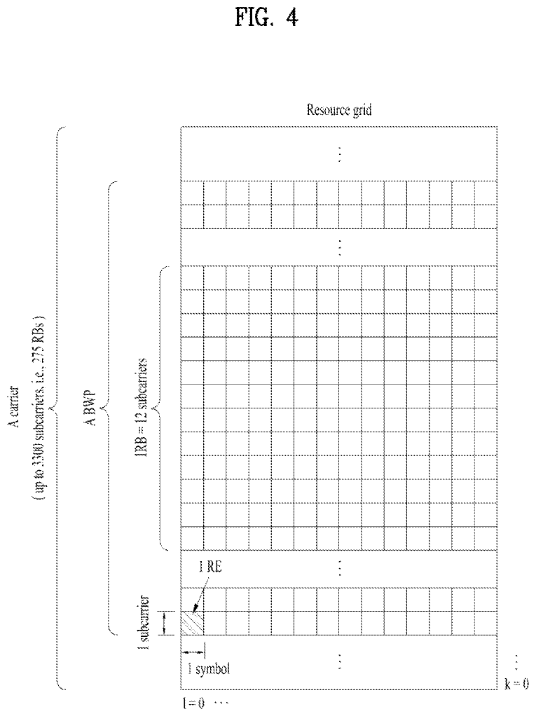

FIG. 4 illustrates the slot structure of a NR frame.

Referring to FIG. 4, one slot includes a plurality of symbols in the time domain. For example, one slot may include 14 symbols in a normal CP and 12 symbols in an extended CP. Alternatively, one slot may include 7 symbols in the normal CP and 6 symbols in the extended CP.

A carrier may include a plurality of subcarriers in the frequency domain. A resource block (RB) is defined as a plurality of consecutive subcarriers (e.g., 12 subcarriers) in the frequency domain. A bandwidth part (BWP) may be defined as a plurality of consecutive (P)RBs in the frequency domain, and the BWP may correspond to one numerology (e.g., SCS, CP length, etc.). The carrier may include up to N (e.g., 5) BWPs. Data communication may be conducted in an activated BWP. In a resource grid, each element may be referred to as a resource element (RE) and may be mapped to one complex symbol.

The wireless interface between UEs or the wireless interface between a UE and a network may be composed of an L1 layer, an L2 layer, and an L3 layer. In various embodiments of the present disclosure, the L1 layer may represent a physical layer. The L2 layer may represent, for example, at least one of a MAC layer, an RLC layer, a PDCP layer, and an SDAP layer. The L3 layer may represent, for example, an RRC layer.

### Bandwidth Part (BWP)

In the NR system, up to 400 MHz may be supported per component carrier (CC). If a UE operating on a wideband CC always operates with the RF for the entire CCs turned on, the battery consumption of the UE may be increased. Alternatively, considering various use cases (e.g., eMBB, URLLC, Mmtc, V2X, etc.) operating within one wideband CC, different numerologies (e.g., sub-carrier spacings) may be supported for different frequency bands within a specific CC. Alternatively, the capability for the maximum bandwidth may differ among the UEs. In consideration of this, the BS may instruct the UE to operate only in a partial bandwidth, not the entire bandwidth of the wideband CC. The partial bandwidth is defined as a bandwidth part (BWP) for simplicity. Here, the BWP may be composed of resource blocks (RBs) contiguous on the frequency axis, and may correspond to one numerology (e.g., sub-carrier spacing, CP length, slot/mini-slot duration).

The BS may configure multiple BWPs in one CC configured for the UE. For example, a BWP occupying a relatively small frequency region may be configured in a PDCCH monitoring slot, and a PDSCH indicated by the PDCCH in a larger BWP may be scheduled. Alternatively, when UEs are concentrated in a specific BWP, some of the UEs may be configured in another BWP for load balancing. Alternatively, a spectrum in the middle of the entire bandwidth may be punctured and two BWPs on both sides may be configured in the same slot in consideration of frequency-domain inter-cell interference cancellation between neighbor cells. That is, the BS may configure at least one DL/UL BWP for the UE associated with the wideband CC and activate at least one DL/UL BWP among the configured DL/UL BWP(s) at a specific time (through L1 signaling, MAC CE or RRC signalling, etc.). The BS may instruct the UE to switch to another configured DL/UL BWP (through L1 signaling, MAC CE or RRC signalling, etc.). Alternatively, when a timer expires, the UE may switch to a predetermined DL/UL BWP. The activated DL/UL BWP is defined as an active DL/UL BWP. The UE may fail to receive DL/UL BWP configuration during an initial access procedure or before an RRC connection is set up. A DL/UL BWP assumed by the UE in this situation is defined as an initial active DL/UL BWP.

For example, when a specific field indicating a BWP (e.g., a BWP indicator field) is included in DCI (e.g., DCI format 1_1) for PDSCH scheduling, a value of the field may be configured to indicate a specific DL BWP (e.g., active DL BWP) from a (pre)configured DL BWP set for DL reception for a LT. In this case, the UE that receives the DCI may be configured to receive DL data in a specific DL BWP indicated by the corresponding field. And/or, when a specific field indicating a BWP (e.g., BWP indicator field) is included in the DCI (e.g., DCI format 0_1) for PUSCH scheduling, a value of the corresponding field may be configured to indicate a specific UL BWP (e.g., active UL BWP) from a (pre)configured DL BWP set for UL transmission to the UE. In this case, the UE that receives the DCI may be configured to transmit UL data in a specific UL BWP indicated by the corresponding field.

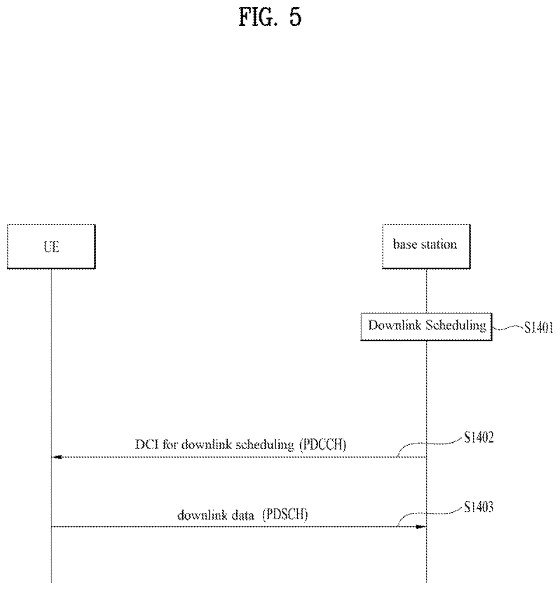

FIG. 5 illustrates a procedure in which a base station transmits a downlink (DL) signal to a UE

[symbol]

Referring to FIG. 5, the BS schedules DL transmission in relation to, for example, frequency/time resources, a transport layer, a DL precoder, and an MCS (S1401). In particular, the BS may determine a beam for PDSCH transmission to the UE through the above-described operations.

The UE receives downlink control information (DCI) for DL scheduling (i.e., including scheduling information about the PDSCH) from the BS on the PDCCH (S1402).

DCI format 1_0 or 1_1 may be used for DL scheduling. In particular, DCI format 1_1 includes the following information: an identifier for DCI formats, a bandwidth part indicator, frequency domain resource assignment, time domain resource assignment, a PRB bundling size indicator, a rate matching indicator, a ZP CSI-RS trigger, antenna port(s), transmission configuration indication (TCI), an SRS request, and a demodulation reference signal (DMRS) sequence initialization.

In particular, according to each state indicated in the antenna port(s) field, the number of DMRS ports may be scheduled, and single-user (SU)/multi-user (MU) transmission may also be scheduled.

In addition, the TCI field is configured in 3 bits, and the QCL for the DMRS is dynamically indicated by indicating a maximum of 8 TCI states according to the value of the TCI field.

The UE receives DL data from the BS on the PDSCH (S1403).

When the UE detects a PDCCH including DCI format 1_0 or 1_1, it decodes the PDSCH according to an indication by the DCI. Here, when the UE receives a PDSCH scheduled by DCI format 1, a DMRS configuration type may be configured for the UE by a higher layer parameter ‘dmrs-Type’, and the DMRS type is used to receive the PDSCH. In addition, the maximum number of front-loaded DMRS symbols for the PDSCH may be configured for the UE by the higher layer parameter ‘maxLength’.

In the case of DMRS configuration type 1, when a single codeword is scheduled for the UE and an antenna port mapped to an index of {2, 9, 10, 11, or 30} is specified, or when two codewords are scheduled for the UE, the UE assumes that any of the remaining orthogonal antenna ports is not associated with PDSCH transmission to another UE.

Alternatively, in the case of DMRS configuration type 2, when a single codeword is scheduled for the UE and an antenna port mapped to an index of {2, 10, or 23} is specified, or when two codewords are scheduled for the UE, the UE assumes that any of the remaining orthogonal antenna ports is not associated with PDSCH transmission to another UE.

When the UE receives the PDSCH, it may assume that the precoding granularity P′ is a consecutive resource block in the frequency domain. Here, P′ may correspond to one of {2, 4, wideband}.

When P′ is determined as wideband, the UE does not expect scheduling with non-contiguous PRBs, and may assume that the same precoding is applied to the allocated resources.

On the other hand, when P′ is determined as any one of {2, 4}, a precoding resource block group (PRG) is divided into P′ contiguous PRBs. The number of actually contiguous PRBs in each PRG may be greater than or equal to 1. The UE may assume that the same precoding is applied to contiguous DL PRBs in the PRG.

In order to determine a modulation order, a target code rate, and a transport block size in the PDSCH, the UE first reads the 5-bit MCD field in the DCI, and determines the modulation order and the target code rate. Then, it reads the redundancy version field in the DCI, and determines the redundancy version. Then, the UE determines the transport block size based on the number of layers and the total number of allocated PRBs before rate matching.

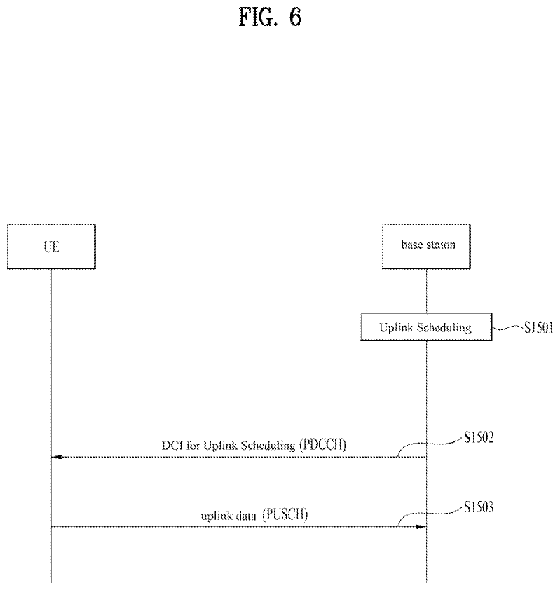

FIG. 6 illustrates a procedure in which a UE transmits an uplink (UL) signal to a BS.

Referring to FIG. 6, the BS schedules UL transmission in relation to, for example, frequency/time resources, a transport layer, a UL precoder, and an MCS (S1501). In particular, the BS may determine, through the above-described operations, a beam for PUSCH transmission of the UE.

The UE receives DCI for UL scheduling (including scheduling information about the PUSCH) from the BS on the PDCCH (S1502).

DCI format 0_0 or 0_1 may be used for UL scheduling. In particular, DCI format 0_1 includes the following information: an identifier for DCI formats, a UL/supplementary UL (SUL), a bandwidth part indicator, frequency domain resource assignment, time domain resource assignment, a frequency hopping flag, a modulation and coding scheme (MCS), an SRS resource indicator (SRI), precoding information and number of layers, antenna port(s), an SRS request, DMRS sequence initialization, and UL shared channel (UL-SCH) indicator.

In particular, SRS resources configured in an SRS resource set associated with the higher layer parameter ‘usage’ may be indicated by the SRS resource indicator field. In addition, spatialRelationInfo' may be configured for each SRS resource, and the value thereof may be one of {CRI, SSB, SRI}.

The UE transmits UL data to the BS on PUSCH (S1503).

When the UE detects a PDCCH including DCI format 0_0 or 0_1, it transmits the PUSCH according to an indication by the DCI.

For PUSCH transmission, two transmission schemes are supported: codebook-based transmission and non-codebook-based transmission:
i) When the higher layer parameter ‘txConfig’ is set to ‘codebook’, the UE is configured for codebook-based transmission. On the other hand, when the higher layer parameter ‘txConfig’ is set to ‘nonCodebook’, the UE is configured for non-codebook based transmission. When the higher layer parameter ‘txConfig’ is not configured, the UE does not expect scheduling by DCI format 0_1. When the PUSCH is scheduled according to DCI format 0_0, PUSCH transmission is based on a single antenna port.

In the case of codebook-based transmission, the PUSCH may be scheduled by DCI format 0_0 or DCI format 0_1, or scheduled semi-statically. When the PUSCH is scheduled by DCI format 0_1, the UE determines the PUSCH transmission precoder based on the SRI, transmit precoding matrix indicator (TPMI) and transmission rank from the DCI, as given by the SRS resource indicator field and the precoding information and number of layers field. The TPMI is used to indicate a precoder to be applied across antenna ports, and corresponds to an SRS resource selected by the SRI when multiple SRS resources are configured. Alternatively, when a single SRS resource is configured, the TPMI is used to indicate a precoder to be applied across antenna ports, and corresponds to the single SRS resource. A transmission precoder is selected from the UL codebook having the same number of antenna ports as the higher layer parameter ‘nrofSRS-Ports’. When the higher layer in which the UE is set to ‘codebook’ is configured with the parameter ‘txConfig’, at least one SRS resource is configured for the UE. The SRI indicated in slot n is associated with the most recent transmission of the SRS resource identified by the SRI, where the SRS resource precedes the PDCCH carrying the SRI (i.e., slot n).
ii) In the case of non-codebook-based transmission, the PUSCH may be scheduled by DCI format 0_0 or DCI format 0_1, or scheduled semi-statically. When multiple SRS resources are configured, the UE may determine the PUSCH precoder and transmission rank based on the wideband SRI. Here, the SRI is given by the SRS resource indicator in the DCI or by the higher layer parameter ‘srs-ResourceIndicator’. The UE may use one or multiple SRS resources for SRS transmission. Here, the number of SRS resources may be configured for simultaneous transmission within the same RB based on UE capability. Only one SRS port is configured for each SRS resource. Only one SRS resource may be configured by the higher layer parameter ‘usage’ set to ‘nonCodebook’. The maximum number of SRS resources that may be configured for non-codebook-based UL transmission is 4. The SRI indicated in slot n is associated with the most recent transmission of the SRS resource identified by the SRI, where the SRS transmission precedes the PDCCH carrying the SRI (i.e., slot n).

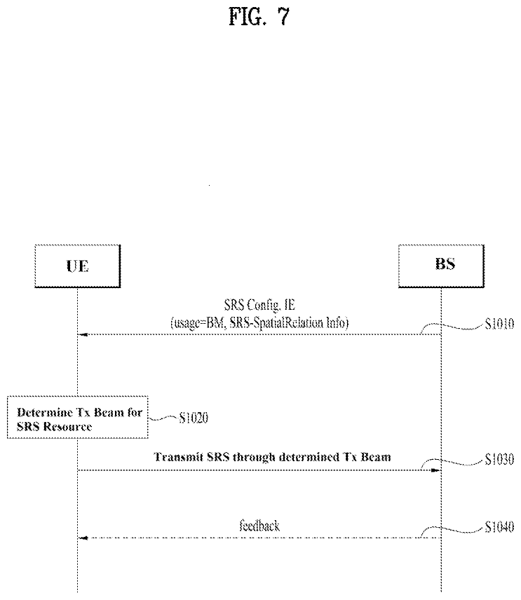

FIG. 7 is a flowchart showing an example of a UL BM procedure using a SRS.

Referring to FIG. 7, in UL BM, beam reciprocity (or beam correspondence) between a Tx beam and a Rx beam may or may not be established according to UE implementation. When reciprocity between the Tx beam and the Rx beam is established in both the BS and the UE, a UL beam pair may be aligned through a DL beam pair. However, when reciprocity between the Tx beam and the Rx beam is not established in either of the BS and the UE, a UL beam pair determination process may be required separately from DL beam pair determination.

The UE may receive RRC signaling (e.g., SRS-Config IE) including a (higher layer parameter) usage parameter configured to ‘beam management’ (S1010).

The UE may determine the Tx beam for a SRS resource to be transmitted based on SRS-SpatialRelation Info included in the SRS-Config IE (S1020). Here, the SRS-SpatialRelation Info may be configured for each SRS resource, and may indicate whether to apply the same beam as the beam used in SSB, CSI-RS, or SRS for each SRS resource. In addition, SRS-SpatialRelationInfo may or may not be configured in each SRS resource. When the SRS-SpatialRelationInfo is configured in the SRS resource, the same beam as the beam used in SSB, CSI-RS or SRS may be applied and transmitted. However, when SRS-SpatialRelationInfo is not configured to the SRS resource, the UE may arbitrarily determine a Tx beam and may transmit the SRS through the determined Tx beam (S1030).

In more detail, for P-SRS in which ‘SRS-ResourceConfigType’ is configured ‘periodically’:
i) When the SRS-SpatialRelationInfo is configured to ‘SSB/PBCH’, the UE may apply the same spatial domain transmission filter (or generated from the corresponding filter) as a spatial domain Rx filter used to receive a SSB/PBCH and may transmit the corresponding SRS resource; or
ii) When the SRS-SpatialRelationInfo is configured to a ‘CSI-RS’, the UE may apply the same spatial domain transmission filter as a filter used to receive a periodic CSI-RS or a SP CSI-RS and may transmit a SRS resource; or
iii) When the SRS-SpatialRelationInfo is configured to a ‘SRS’, the UE may apply the same spatial domain transmission filter as a filter used to transmit a periodic SRS and may transmit the corresponding SRS resource.

Even when the ‘SRS-ResourceConfigType’ is configured to a ‘SP-SRS’ or an ‘AP-SRS’, beam determination and transmission operations may be applied similar to the above.
Additionally, the UE may or may not receive feedback to the SRS from the BS as in the following three cases (S1040)
i) When Spatial_Relation_Info is configured for all SRS resources in an SRS resource set, the UE may transmit an SRS in a beam indicated by the BS. For example, when Spatial_Relation_Info all indicate the same SSB, CRI, or SRI, the UE may repeatedly transmit the SRS in the same beam.
ii) Spatial_Relation_Info may not be configured for all SRS resources in the SRS resource set. In this case, the UE may freely perform transmission while changing the SRS beam.
iii) Spatial_Relation_Info may be configured only for some SRS resources in the SRS resource set. In this case, for the configured SRS resource, the SRS may be transmitted in the indicated beam, and for the SRS resource for which Spatial_Relation_Info is not configured, the UE may arbitrarily apply the Tx beam to perform transmission.

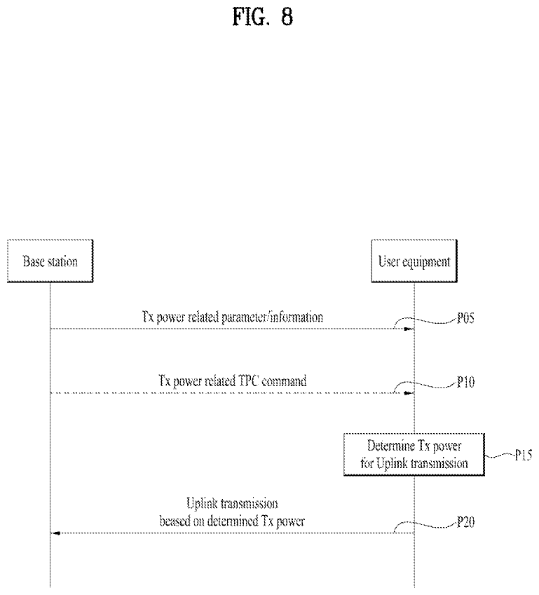

FIG. 8 shows an example of a procedure for controlling uplink transmit power.

First, a user equipment (UE) may receive a parameter and/or information related to transmit power (Tx power) from a base station (BS) (P05). In this case, the UE may receive the corresponding parameter and/or information through higher layer signaling (e.g., RRC signaling or MAC-CE), etc. For example, in relation to PUSCH transmission, PUCCH transmission, SRS transmission, and/or PRACH transmission, the UE may receive the parameter and/or information related to Tx power control.

Then, the UE may receive a TPC command (TPC command) related to Tx power from the BS (P10). In this case, the UE may receive the corresponding TPC command through lower layer signaling (e.g., DCI), etc. For example, in relation to PUSCH transmission, PUCCH transmission, and/or SRS transmission, the UE may receive information about a TPC command to be used for determination of a power control adjustment state, etc. through a TPC command field of a predefined DCI format. However, in the case of PRACH transmission, the corresponding step may be omitted.

Then, the UE may determine (or calculate) Tx power for uplink transmission based on the parameter, information, and/or TPC command received from the BS (P15). For example, the UE may determine PUSCH Tx power (or PUCCH Tx power, SRS Tx power, and/or PRACH Tx power) based on Equation 1 below. And/or, when two or more uplink channels and/or signals need to be transmitted overlappingly, such as in a situation such as carrier aggregation, the UE may also determine Tx power for uplink transmission in consideration of priority order (priority) and the like.

Then, the UE may transmit one or more uplink channels and/or signals (e.g., PUSCH, PUCCH, SRS, or PRACH) to the BS based on the determined (or calculated) Tx power (P20).

Hereinafter, content related to power control will be described.

In a wireless communication system, it may be necessary to increase or decrease Tx power of a UE (e.g., User Equipment (UE)) and/or a mobile device if necessary. In this way, control of the Tx power of the UE and/or the mobile device may be referred to as uplink power control. For example, the Tx power control method may be applied to satisfy a requirement (e.g., SNR (Signal-to-Noise Ratio), BER (Bit Error Ratio), or BLER (Block Error Ratio)) in the BS (e.g., gNB, eNB, etc.) etc.).

The above described power control may be performed in an open-loop power control scheme and a closed-loop power control scheme.

In detail, the open-loop power control scheme refers to a method of controlling Tx power without feedback from a transmitting device (e.g., BS) to a receiving device (e.g., UE) and/or feedback from the receiving device to the transmitting device. For example, the UE may receive a specific channel/signal (pilot channel/signal) from the BS, and may estimate the strength of received power using the received channel/signal. Then, the UE may control the Tx power using the estimated strength of the received power.

In contrast, the closed-loop power control scheme refers to a method of controlling Tx power based on feedback from the transmitting device to the receiving device and/or feedback from the receiving device to the transmitting device. For example, the BS may receive a specific channel/signal from the UE, and may determine an optimum power level of the UE based on the power level, SNR, BER, BLER, etc. measured through the received specific channel/signal. The BS may transfer information (i.e., feedback) on the determined optimum power level to the UE through a control channel or the like, and the corresponding UE may control Tx power using the feedback provided by the BS.

Hereinafter, a power control method for cases in which a UE and/or a mobile device performs uplink transmission on a BS in a wireless communication system will be described.

In detail, hereinafter, power control methods for transmission of 1) a UL data channel (e.g., PUSCH (Physical Uplink Shared Channel)), 2) an uplink control channel (e.g., PUCCH (Physical Uplink Control Channel)), 3) a Sounding Reference Signal (SRS), and 4) a random access channel (e.g., PRACH (Physical Random Access Channel)) will be described. In this case, a transmission occasion (i.e., a transmission time unit) (i) for a PUSCH, a PUCCH, an SRS, and/or a PRACH may be defined by a slot index (n_s), a first symbol (S) in a slot, the number of consecutive symbols (L), and the like in a frame of a system frame number (SFN).

Hereinafter, for convenience of description, a power control method will be described based on a case in which the UE performs PUSCH transmission. Needless to say, the corresponding method may be extensively applied to other UL data channels supported in a wireless communication system.

In the case of PUSCH transmission in an activated (active) UL bandwidth part (UL BWP) of a carrier (carrier) (f) of a serving cell (c), the UE may calculate a linear power value of Tx power determined using Equation P1 below. Then, the UE may control the Tx power in consideration of the number of antenna ports and/or the number of SRS ports.

In detail, when performing PUSCH transmission in an activated UL BWP (b) of a carrier (f) of a serving cell (c) using a parameter set configuration based on an index j and a PUSCH power control adjustment state based on an index 1, the UE may determine PUSCH Tx power P_{PUSCH,b,f,c}(i, j, q_{d},l) (dBm) in the PUSCH transmission occasion (i) based on Equation 1 below.

$${P}_{PUSCH , b , f , c} ( i , j , {q}_{d} , l ) = min \{ \begin{matrix}{P}_{CMAX , f , c} ( i ) , \\ \begin{matrix}{P}_{O \_ PUSCH , b , f , c} ( j ) + 10 {log}_{10} ( {2}^{μ} \cdot {M}_{RB , b , f , c}^{PUSCH} ( i ) ) + \\ {α}_{b , f , c} ( j ) \cdot {PL}_{b , f , c} ( {q}_{d} ) + {Δ}_{TF , b , f , c} ( i ) + {f}_{b , f , c} ( i , l )\end{matrix}\end{matrix} \} [ dBm ] \qquad [ Equation 1 ]$$

In Equation 1, index j may refer to an index for an open-loop power control parameter (e.g., Po or alpha) and may be configured with the maximum of 32 parameter sets per cell. index q_d may refer to an index of a DL RS resource for PathLoss (PL) measurement and may be configured with the maximum of 4 measurements per cell. index 1 may refer to an index for a closed-loop power control process and may be configured with the maximum of 2 processes per cell.

In detail, Po may be a parameter broadcast as a part of system information, and may indicate a target reception power at a receiving side. The corresponding Po value may be configured in consideration of UE throughput, cell capacity, noise, and/or interference. In addition, alpha may indicate a rate at which compensation for path loss is performed. Alpha may be set to a value from 0 to 1, and full pathloss compensation or fractional pathloss compensation may be performed according to the set value. In this case, the alpha value may be set in consideration of interference between UEs and/or data rates. In addition, P_{CMAX, f, c}(i) may represent the configured UE Tx power. For example, the configured UE Tx power may be interpreted as ‘configured maximum UE output power’ defined in 3GPP TS 38.101-1 and/or TS38.101-2. In addition, M_{RB,b,f,c}^{PUSCH}(i) may represent a bandwidth of PUSCH resource allocation expressed by the number of resource blocks (RBs) for a PUSCH transmission occasion based on subcarrier spacing. In addition, f_{b,f,c}(i,l) related to the PUSCH power control adjustment state may be configured or indicated based on a TPC command field of DCI (e.g., DCI format 0_0, DCI format 0_1, DCI format 2_2, or DCI format2_3).

In this case, a specific RRC (Radio Resource Control) parameter (e.g., SRI-PUSCHPowerControl-Mapping) may represent a linkage between an SRI (SRS Resource Indicator) field of DCI (downlink control information) and the above-mentioned indexes j, q_d, and l. In other words, the above-described indexes j, l, and q_d may be related to a beam, a panel, and/or a spatial domain transmission filter based on specific information. Through this, PUSCH Tx power control in units of beams, panels, and/or spatial domain transmission filters may be performed.

Parameters and/or information for the above-described PUSCH power control may be individually (i.e., independently) configured for each BWP. In this case, the corresponding parameters and/or information may be configured or indicated through higher layer signaling (e.g., RRC signaling or Medium Access Control-Control Element (MAC-CE)) and/or DCI. For example, parameters and/or information for PUSCH power control may be transferred through RRC signaling PUSCH-ConfigCommon, PUSCH-PowerControl, and the like.

Hereinafter, contents related to power headroom report will be described.

The power headroom report may be performed in order for the UE to provide the following information to the BS. Hereinafter, nominal maximum transmit power may be P_{CMAX, f,c}(i), which is the configured UE transmission and the configured maximum UE output power.

Type 1 power headroom: Difference between nominal maximum transmit power for each activated serving cell and estimated Tx power of UL-SCH/PUSCH

Type 2 power headroom: Difference between estimated Tx power of PUCCH and UL-SCH/PUSCH transmitted on SpCell of another MAC entity (i.e. E-UTRA MAC entity in EN-DC) and nominal maximum transmit power in corresponding SpCell

Type 3 power headroom: Type 3 power headroom: Difference between nominal maximum transmit power for each activated serving cell and estimated Tx power of SRS

When the UE is configured with two uplink carriers in a serving cell and determines the Type 1 power headroom report and the Type 3 power headroom report in the serving cell, if both the Type 1 power headroom report and the Type 3 power headroom report are determined based on actual transmission or based on reference transmissions, the UE may perform the Type 1 power headroom report. Alternatively, when one of the Type 1 power headroom report or the Type 3 power headroom report is determined based on reference transmission, the UE may perform the power headroom report (e.g. Type 1 or Type 3) determined based on actual transmission.

In addition, the virtual PH below may refer to the Type 1 power headroom, the Type 2 power headroom, and/or the Type 3 power headroom determined based on reference transmission.

PHR-Config configured to the UE by the B S in order to perform power headroom reporting may be defined as shown in Table 5 below.

PHR-Config configured to the UE by the B S in order to perform power headroom reporting may be defined as shown in Tables 5 and 6 below.

TABLE 5
- PHR-Config
The IE PHR-Config is used to configure parameters for power headroom
reporting.
PHR-Config information element
-- ASN1START
-- TAG-PHR-CONFIG-START
PHR-Config ::= SEQUENCE {
phr-PeriodicTimer ENUMERATED {sf10, sf20, sf50, sf100, sf200,sf500,
sf1000, infinity},
phr-ProhibitTimer ENUMERATED {sf0, sf10, sf20, sf50, sf100,sf200,
sf500, sf1000},
phr-Tx-PowerFactorChange ENUMERATED {dB1, dB3, dB6, infinity},
multiplePHR BOOLEAN,
dummy BOOLEAN,
phr-Type2OtherCell BOOLEAN,
phr-ModeOtherCG ENUMERATED {real, virtual},
...
}
-- TAG-PHR-CONFIG-STOP
-- ASN1STOP

TABLE 6
PHR-Config field descriptions

dummy
This field is not used in this version of the specification and the UE ignores the received value.
multiplePHR
Indicates if power headroom shall be reported using the Single Entry PHR MAC control element
or Multiple Entry PHR MAC control element defined in TS 38.321 [3]. True means to use
Multiple Entry PHR MAC control element and False means to use the Single Entry PHR MAC
control element defined in TS 38.321 [3]. The network configures this field to true for MR-DC
and UL CA for NR, and to false in all other cases.
phr-ModeOtherCG
Indicates the mode (i.e. real or virtual) used for the PHR of the activated cells that are part of the
other Cell Group (i.e. MCG or SCG), when DC is configured. If the UE is configured with only
one cell group (no DC), it ignores the field.
phr-Periodic Timer
Value in number of subframes for PHR reporting as specified in TS 38.321 [3].
Value sf10 corresponds to 10 subframes, value sf20 corresponds to 20 subframes, and so on.
phr-ProhibitTimer
Value in number of subframes for PHR reporting as specified in TS 38.321 [3].
Value sf0 corresponds to 0 subframe, value sf10 corresponds to 10 subframes,
value sf20 corresponds to 20 subframes, and so on.
phr-Tx-PowerFactorChange
Value in dB for PHR reporting as specified in TS 38.321 [3]. Value dB1 corresponds to 1 dB,
dB3 corresponds to 3 dB and so on. The same value applies for each serving cell (although the
associated functionality is performed independently for each cell).
phr-Type2OtherCell
If set to true, the UE shall report a PHR type 2 for the SpCell of the other MAC entity. See TS
38.321 [3], clause 5.4.6. Network sets this field to false if the UE is not configured with an E-
UTRA MAC entity.

As described above, the UE may transfer value(s) for the Type 1/2/3 power headroom reports to a MAC layer in a physical layer of the UE using information preconfigured from the BS, and the MAC layer may transfer/report the value(s) received (i.e., transferred) from the physical layer (e.g., power headroom(s) and/or PCMAX(s)) to the BS through MAC-CE (e.g., single Entry PHR MAC CE or Multiple Entry PHR MAC CE). For example, the MAC CE for the corresponding power headroom report may be transferred/reported to the BS and may also be transferred/reported to the BS through subsequent uplink transmission.

### Non-Terrestrial Networks Reference

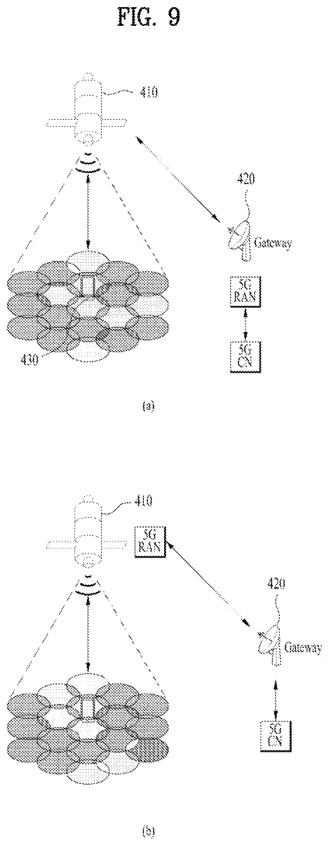

FIG. 9 illustrates a non-terrestrial network (NTN).

A non-terrestrial network (NTN) refers to a wireless network configured using satellites (e.g., geostationary earth orbit satellites (GEO)/low-earth orbit satellites (LEO)). Based on the NTN, coverage may be extended and a highly reliable network service may be provided. For example, the NTN may be configured alone, or may be combined with a conventional terrestrial network to configure a wireless communication system. For example, in the NTN network, i) a link between a satellite and a UE, ii) a link between satellites, iii) a link between a satellite and a gateway, and the like may be configured.

The following terms may be used to describe the configuration of a wireless communication system employing satellites.
Satellite: a space-borne vehicle embarking a bent pipe payload or a regenerative payload telecommunication transmitter, placed into Low-Earth Orbit (LEO) typically at an altitude between 500 km to 2000 km, Medium-Earth Orbit (MEO) typically at an altitude between 8000 to 20000 lm, or Geostationary satellite Earth Orbit (GEO) at 35 786 km altitude.
Satellite network: Network, or segments of network, using a space-borne vehicle to embark a transmission equipment relay node or base station.
Satellite RAT: a RAT defined to support at least one satellite.
5G Satellite RAT: a Satellite RAT defined as part of the New Radio.
5G satellite access network: 5G access network using at least one satellite.
Terrestrial: located at the surface of Earth.
Terrestrial network: Network, or segments of a network located at the surface of the Earth.

Use cases that may be provided by a communication system employing a satellite connection may be divided into three categories. The “Service Continuity” category may be used to provide network connectivity in geographic areas where 5G services cannot be accessed through the wireless coverage of terrestrial networks. For example, a satellite connection may be used for a UE associated with a pedestrian user or a UE on a moving land-based platform (e.g., car, coach, truck, train), air platform (e.g., commercial or private jet) or marine platform (e.g., marine vessel). In the “Service Ubiquity” category, when terrestrial networks are unavailable (due to, for example, disaster, destruction, economic situations, etc.), satellite connections may be used for IOT/public safety-related emergency networks/home access, etc. The “Service Scalability” category includes services using wide coverage of satellite networks.

For example, a 5G satellite access network may be connected to a 5G core Network. In this case, the satellite may be a bent pipe satellite or a regenerative satellite. The NR radio protocols may be used between the UE and the satellite. Also, F1 interface may be used between the satellite and the gNB.

As described above, a non-terrestrial network (NTN) refers to a wireless network configured using a device that is not fixed on the ground, such as satellite. A representative example is a satellite network. Based on the NTN, coverage may be extended and a highly reliable network service may be provided. For example, the NTN may be configured alone, or may be combined with an existing terrestrial network to configure a wireless communication system.

Use cases that may be provided by a communication system employing an NTN may be divided into three categories. The “Service Continuity” category may be used to provide network connectivity in geographic areas where 5G services cannot be accessed through the wireless coverage of terrestrial networks. For example, a satellite connection may be used for a UE associated with a pedestrian user or a UE on a moving land-based platform (e.g., car, coach, truck, train), air platform (e.g., commercial or private jet) or marine platform (e.g., marine vessel). In the “Service Ubiquity” category, when terrestrial networks are unavailable (due to, for example, disaster, destruction, economic situations, etc.), satellite connections may be used for IOT/public safety-related emergency networks/home access, etc. The “Service Scalability” category includes services using wide coverage of satellite networks.

Referring to FIG. 9, the NTN includes one or more satellites 410, one or more NTN gateways 420 capable of communicating with the satellites, and one or more UEs (/B Ss) 430 capable of receiving mobile satellite services from the satellites. For simplicity, the description is focused on the example of the NTN including satellites, but is not intended to limit the scope of the present disclosure. Accordingly, the NTN may include not only the satellites, but also aerial vehicles (Unmanned Aircraft Systems (UAS) encompassing tethered UAS (TUA), Lighter than Air UAS (LTA), Heavier than Air UAS (HTA), all operating in altitudes typically between 8 and 50 km including High Altitude Platforms (HAPs)).

The satellite 410 is a space-borne vehicle equipped with a bent pipe payload or a regenerative payload telecommunication transmitter and may be located in a low earth orbit (LEO), a medium earth orbit (MEO), or a geostationary earth orbit (GEO). The NTN gateway 420 is an earth station or gateway existing on the surface of the earth, and provides sufficient RF power/sensitivity to access the satellite. The NTN gateway corresponds to a transport network layer (TNL) node.

The NTN may have i) a link between a satellite and a UE, ii) a link between satellites, iii) a link between a satellite and an NTN gateway. A service link refers to a radio link between a satellite and a UE. Inter-satellite links (ISLs) between satellites may be present when there are multiple satellites. A feeder link refers to a radio link between an NTN gateway and a satellite (or UAS platform). The gateway may be connected to a data network and may communicate with a satellite through the feeder link. The UE may communicate via the satellite and service link.

As NTN operation scenarios, two scenarios which are based on transparent payload and regenerative payload, respectively may be considered. FIG. 9-(a) shows an example of a scenario based on a transparent payload. In the scenario based on the transparent payload, the signal repeated by the payload is not changed. The satellites 410 repeat the NR-Uu radio interface from the feeder link to the service link (or vice versa), and the satellite radio interface (SRI) on the feeder link is NR-Uu. The NTN gateway 420 supports all functions necessary to transfer the signal of the NR-Uu interface. Also, different transparent satellites may be connected to the same gNB on the ground. FIG. 9-(b) shows an example of a scenario based on a regenerative payload. In the scenario based on the regenerative payload, the satellite 410 may perform some or all of the functions of a conventional BS (e.g., gNB), and may thus perform some or all of frequency conversion/demodulation/decoding/modulation. The service link between the UE and a satellite is established using the NR-Uu radio interface, and the feeder link between the NTN gateway and a satellite is established using the satellite radio interface (SRI). The SRI corresponds to a transport link between the NTN gateway and the satellite.

The UE 430 may be connected to SGCN through an NTN-based NG-RAN and a conventional cellular NG-RAN simultaneously. Alternatively, the UE may be connected to the SGCN via two or more NTNs (e.g., LEO NTN and GEO NTN, etc.) simultaneously.

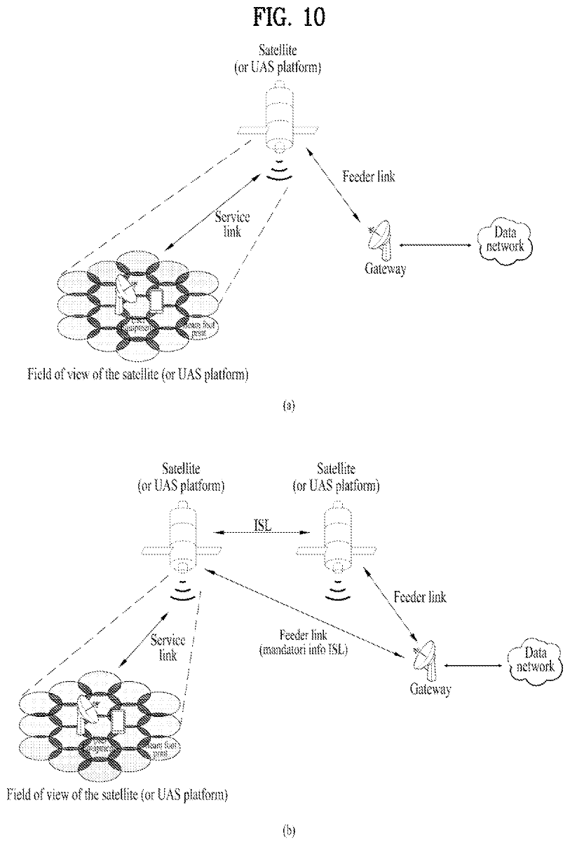

FIG. 10 illustrates an overview and a scenario of an NTN.

NTN refers to a network or network segment in which a satellite (or UAS platform) uses RF resources. Typical scenarios of the NTN providing access to a UE include an NTN scenario based on a transparent payload as shown in FIG. 10-(a) and an NTN scenario based on a regenerative payload as shown in FIG. 10-(b).

NTN typically features the following elements,
One or several sat-gateways that connect the Non-Terrestrial Network to a public data network
A GEO satellite is fed by one or several sat-gateways which are deployed across the satellite targeted coverage (e.g. regional or even continental coverage). We assume that UE in a cell are served by only one sat-gateway.

A Non-GEO satellite served successively by one or several sat-gateways at a time. The system ensures service and feeder link continuity between the successive serving sat-gateways with sufficient time duration to proceed with mobility anchoring and hand-over.
A feeder link or radio link between a sat-gateway and the satellite (or UAS platform)
A service link or radio link between the user equipment and the satellite (or UAS platform).
A satellite (or UAS platform) which may implement either a transparent or a regenerative (with on board processing) payload. The satellite (or UAS platform) generate beams typically generate several beams over a given service area bounded by its field of view. The footprints of the beams are typically of elliptic shape. The field of view of a satellites (or UAS platforms) depends on the on board antenna diagram and min elevation angle.
A transparent payload: Radio Frequency filtering, Frequency conversion and amplification. Hence, the waveform signal repeated by the payload is un-changed;
A regenerative payload: Radio Frequency filtering, Frequency conversion and amplification as well as demodulation/decoding, switch and/or routing, coding/modulation. This is effectively equivalent to having all or part of base station functions (e.g. gNB) on board the satellite (or UAS platform).
Inter-satellite links (ISL) optionally in case of a constellation of satellites. This will require regenerative payloads on board the satellites. ISL may operate in RF frequency or optical bands.
User Equipment is served by the satellite (or UAS platform) within the targeted service area.

Table 7 below defines various types of satellites (or UAS platforms).

TABLE 7

| | | | | Typical beam | |
|---|---|---|---|---|---|
| Platforms | Altitude range | | Orbit | footprint size | |
| Low-Earth Orbit | 300-1500 | km | Circular around the earth | 100-1000 | km |
| (LEO) satellite | | | | | |
| Medium-Eart Orbit | 7000-25000 | km | | 100-1000 | km |
| (MEO) satellite | | | | | |
| Geostationary Earth | 35 786 | km | notional station keeping | 200-3500 | km |
| Orbit (GEO) satellite | | | position fixed in terms of | | |
| UAS platfor | 8-50 km (20 km | | elevation/azimuth with respect | 5-200 | km |
| (including HAPS) | for HAPS) | | to a given earth point | | |
| High Elliptical Orbit | 400-50000 | km | Elliptical around the earth | 200-3500 | km |
| (HEO) satellite | | | | | |

Typically, GEO satellite and UAS are used to provide continental, regional or local service. A constellation of LEO and MEO is used to provide services in both Northern and Southern hemispheres. In some case, the constellation can even provide global coverage including polar regions. For the later, this requires appropriate orbit inclination, sufficient beams generated and inter-satellite links. REO satellite systems are not considered in this document.

An NTN that provides access to a terminal in six reference scenarios described below can be considered.

Circular orbiting and notional station keeping platforms.

Highest RTD constraint

Highest Doppler constraint

A transparent and a regenerative payload

One ISL case and one without ISL. Regenerative payload is mandatory in the case of inter-satellite links.

Fixed or steerable beams resulting respectively in moving or fixed beam foot print on the ground

Six scenarios are considered as depicted in Table 8 and are detailed in Table 9.

TABLE 8

| | Transparent | Regenerative |
|---|---|---|
| | satellite | satellite |
| GEO based non-terrestrial access network | Scenario A | Scenario B |
| LEO based non-terrestrial access network: | Scenario C1 | Scenario D1 |
| steerable beams | | |
| LEO based non-terrestrial access network: | Scenario C2 | Scenario D2 |
| the beams move with the satellite | | |

TABLE 9

| Scenarios | GEO based non-terrestrial access | LEO based non-terrestrial |
|---|---|---|
| | network (Scenario A and B) | access network (Scenario C & D) |
| Orbit type | notional station keeping position | circular orbiting around the |
| | fixed in terms of elevation/azimuth | earth |
| | with respect to a given earth point | |
| Altitude | 35,786 km | 600 km |
| | | 1,200 km |
| Spectrum (service link) | <6 GHz (e.g. 2 GHz) | |
| | >6 GHz (e.g. DL 20 GHZ, UL 30 GHz) | |
| Max channel bandwidth | 30 MHz for band <6 GHz | |
| capability (service link) | 1 GHz for band >6 GHz | |
| Payload | Scenario A: Transparent (including | Scenario C: Transparent |
| | radio frequency function only) | (including radio frequency |
| | Scenario B: regenerative (including | function only) |
| | all or part of RAN functions) | Scenario D: Regenerative |
| | | (including all or part of RAN |
| | | functions) |
| Inter-Satellite link | No | Scenario C: No |
| | | Scenario D: Yes/No (Both |
| | | cases are possible.) |
| Earth-fixed beams | Yes | Scenario C1: Yes (steerable |
| | | beams), see note 1 |
| | | Scenario C2: No (the beams |
| | | move with the satellite) |
| | | Scenario D 1: Yes (steerable |
| | | beams), see note 1 |
| | | Scenario D 2: No (the beams |
| | | move with the satellite) |
| Max beam foot print size | 3500 km (Note 5) | 1000 km |
| (edge to edge) regardless | | |
| of the elevation angle | | |
| Min Elevation angle for | 10° for service link and 10° for | 10° for service link and 10° |
| both sat-gateway and user | feeder link | for feeder link |
| equipment | | |
| Max distance between | 40,581 km | 1,932 km (600 km altitude) |
| satellite and user | | 3,131 km (1,200 km altitude) |
| equipment at min | | |
| elevation angle | | |
| Max Round Trip Delay | Scenario A: 541.46 ms (service and | Scenario C: (transparent |
| (propagation delay only) | feeder links) | payload: service and feeder |
| | Scenario B: 270.73 ms (service link | links) |
| | only) | 25.77 ms (600 km) |
| | | 41.77 ms (1200 km) |
| | | Scenario D: (regenerative |
| | | payload: service link only) |
| | | 12.89 ms (600 km) |
| | | 20.89 ms (1200 km) |
| Max differential delay | 10.3 ms | 3.12 ms and 3.18 ms for |
| within a cell (Note 6) | | respectively 600 km and |
| | | 1200 km |
| Max Doppler shift (earth | 0.93 ppm | 24 ppm (600 km) |
| fixed user equipment) | | 21 ppm(1200 km) |
| Max Doppler shift | 0.000 045 ppm/s | 0.27 ppm/s (600 km) |
| variation (earth fixed user | | 0.13 ppm/s(1200 km) |
| equipment) | | |
| User equipment motion | 1200 km/h (e.g. aircraft) | 500 km/h (e.g. high speed |
| on the earth | | train) |
| | | Possibly 1200 km/h (e.g. |
| | | aircraft) |
| User equipment antenna | Omnidirectional antenna (linear polarisation), assuming 0 dBi | |
| types | Directive antenna (up to 60 cm equivalent aperture diameter in | |
| | circular polarisation) | |
| User equipment Tx | Omnidirectional antenna: UE power class 3 with up to 200 mW | |
| power | Directive antenna: up to 20 W | |
| User equipment Noise | Omnidirectional antenna: 7 dB | |
| figure | Directive antenna: 1.2 dB | |
| Service link | 3GPP defined New Radio | |
| Feeder link | 3GPP or non-3GPP defined Radio | 3GPP or non-3GPP defined |
| | interface | Radio interface |

NOTE 1:
Each satellite has the capability to steer beams towards fixed points on earth using beamforming techniques. This is applicable for a period of time corresponding to the visibility time of the satellite
NOTE 2:
Max delay variation within a beam (earth fixed user equipment) is calculated based on Min Elevation angle for both gateway and user equipment
NOTE 3:
Max differential delay within a beam is calculated based on Max beam foot print diameter at nadir
NOTE 4:
Speed of light used for delay calculation is 299792458 m/s.
NOTE 5:
The Maximum beam foot print size for GEO is based on current state of the art GEO High Throughput systems, assuming either spot beams at the edge of coverage (low elevation).
NOTE 6:
The maximum differential delay at cell level has been computed considering the one at beam level for largest beam size. It doesn't preclude that cell may include more than one beam when beam size are small or medium size. However the cumulated differential delay of all beams within a cell will not exceed the maximum differential delay at cell level in the table above.

The NTN study results apply to GEO scenarios as well as all NGSO scenarios with circular orbit at altitude greater than or equal to 600 km.

Hereinafter, the NTN reference point will be described.

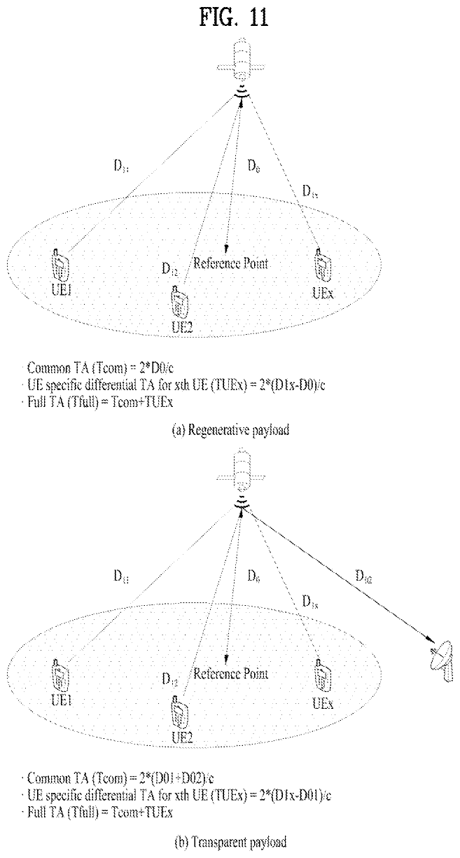

FIG. 11 illustrates TA components of the NTN. Here, the TA offset (NTAoffset) may not be plotted.

With consideration on the larger cell coverage, long round trip time (RTT) and high Doppler, enhancements are considered to ensure the performance for timing and frequency synchronization for UL transmission.

Referring to FIG. 11, a reference point related to timing advance (TA) of initial access and subsequent TA maintenance/management is illustrated. Terms defined in relation to FIG. 11 are described below.
Option 1: Autonomous acquisition of the TA at UE with UE known location and satellite ephemeris.

Regarding option 1, the required TA value for UL transmission including PRACH can be calculated by the UE. The corresponding adjustment can be done, either with UE-specific differential TA or full TA (consisting of UE specific differential TA and common TA).

W.r.t the full TA compensation at the UE side, both the alignment on the UL timing among UEs and DL and UL frame timing at network side can be achieved. However, in case of satellite with transparent payload, further discussion on how to handle the impact introduced by feeder link will be conducted in normative work. Additional needs for the network to manage the timing offset between the DL and UL frame timing can be considered, if impacts introduced by feeder link is not compensated by UE in corresponding compensation.

W.r.t the UE specific differential TA only, additional indication on a single reference point should be signalled to UEs per beam/cell for achieving the UL timing alignment among UEs within the coverage of the same beam/cell. Timing offset between DL and UL frame timing at the network side should also be managed by the network regardless of the satellite payload type.

With concern on the accuracy on the self-calculated TA value at the UE side, additional TA signalling from network to UE for TA refinement, e.g., during initial access and/or TA maintenance, can be determined in the normative work.
Option 2: Timing advanced adjustment based on network indication

Regarding option 2, the common TA, which refers to the common component of propagation delay shared by all UEs within the coverage of same satellite beam/cell, is broadcasted by the network per satellite beam/cell. The calculation of this common TA is conducted by the network with assumption on at least a single reference point per satellite beam/cell.

The indication for UE-specific differential TA from network as the Rel-15 TA mechanism is also needed. For satisfying the larger coverage of NTN, extension of value range for TA indication in RAR, either explicitly or implicitly, is identified. Whether to support negative TA value in corresponding indication will be determined in the normative phase. Moreover, indication of timing drift rate, from the network to UE, is also supported to enable the TA adjustment at UE side.

For calculation of common TA in the above two options, single reference point per beam is considered as the baseline. Whether and how to support the multiple reference points can be further discussed in the normative work.

For the UL frequency compensation, at least for LEO system, the following solutions are identified with consideration on the beam specific post-compensation of common frequency offset at the network side:
Regarding option 1, both the estimation and pre-compensation of UE-specific frequency offset are conducted at the UE side. The acquisition of this value can be done by utilizing DL reference signals, UE location and satellite ephemeris.
Regarding option 2, the required frequency offset for UL frequency compensation at least in LEO systems is indicated by the network to UE. The acquisition on this value can be done at the network side with detection of UL signals, e.g., preamble.

Indication of compensated frequency offset values by the network is also supported in case that compensation of the frequency offset is conducted by the network in the uplink and/or the downlink respectively. However, indication of Doppler drift rate is not necessary.

Hereinafter, more delay-tolerant re-transmission mechanisms will be described in detail.

As follows, two main aspects of a retransmission mechanism with improved delay tolerance can be discussed.
Disabling of HARQ in NR NTN
HARQ optimization in NR-NTN

HARQ Round Trip Time in NR is of the order of several ms. The propagation delays in NTN are much longer, ranging from several milliseconds to hundreds of milliseconds depending on the satellite orbit. The HARQ RTT can be much longer in NTN. It was identified early in the study phase that there would be a need to discuss potential impact and solutions on HARQ procedure. RAN1 has focused on physical layer aspects while RAN2 has focused on MAC layer aspects.

In this regard, disabling of HARQ in NR NTN may be considered.

It was discussed that when UL HARQ feedback is disabled, there could be issues if (i) MAC CE and RRC signalling are not received by UE, or (ii) DL packets not correctly received by UE for a long period of time without gNB knowing it.

The following were discussed without convergence on the necessity of introducing such solutions for NTN when HARQ feedback is disabled
(1) Indicate HARQ disabling via DCI in new/re-interpreted field
(2) New UCI feedback for reporting DL transmission disruption and or requesting DL scheduling changes

The following possible enhancements for slot-aggregation or blind repetitions were considered. There is no convergence on the necessity of introducing such enhancements for NTN.
(1) Greater than 8 slot-aggregation
(2) Time-interleaved slot aggregation
(3) New MCS table

Next, a method for optimizing HARQ for the NR NTN will be described.

Solutions to avoid reduction in peak data rates in NTN were discussed. One solution is to increase the number of HARQ processes to match the longer satellite round trip delay to avoid stop-and-wait in HARQ procedure. Another solution is to disable UL HARQ feedback to avoid stop-and-wait in HARQ procedure and rely on RLC ARQ for reliability. The throughput performance for both types of solutions was evaluated at link level and system level by several contributing companies.

The observations from the evaluations performed on the effect of the number of HARQ processes on performance are summarized as follows:
Three sources provided link-level simulations of throughput versus SNR with the following observations:
One source simulated with a TDL-D suburban channel with elevation angle of 30 degrees with BLER target of 1% for RLC ARQ with 16 HARQ processes, and BLER targets 1% and 10% with 32/64/128/256 HARQ processes. There was no observable gain in throughput with increased number of HARQ processes compared to RLC layer re-transmission with RTT in {32, 64, 128, 256} ms.

One source simulated with a TDL-D suburban channel with elevation angle of 30 degrees with BLER targets of 0.1% for RLC ARQ with 16 HARQ processes, and BLER targets 1% and 10% with 32 HARQ processes. An average throughput gain of 10% was observed with 32 HARQ processes compared to RLC ARQ with 16 HARQ processes with RTT=32 ms.

One source provides the simulation results in following cases with RTT=32 ms, e.g., assuming BLER targets at 1% for RLC ARQ with 16 HARQ processes, BLER targets 1% and 10% with 32 HARQ processes. There is no observable gain in throughput with 32 HARQ processes compared to RLC ARQ with 16 HARQ processes in case that channel is assumed as TDL-D with delay spread/ K-factor taken from system channel model in suburban scenario with elevation angle 30. Performance gain can be observed with other channels, especially, up to 12.5% spectral efficiency gain is achieved in case that channel is assumed as TDL-A in suburban with 30° elevation angle. Moreover, simulation based on the simulation with consideration on other scheduling operations: (i) additional MCS offset, (ii) MCS table based on lower efficiency (iii) slot aggregation with different BLER targets are conducted. Significant gain can be observed with enlarging the HARQ process number.

One source provided system level simulations for LE0=1200 km with 20% resource utilization, 16 and 32 HARQ processes, 15 and 20 UEs per cell, proportional fair scheduling, and no frequency re-use. The spectral efficiency gain per user with 32 HARQ processes compared to 16 HARQ processes depends on the number of UEs. With 15 UEs per beam, an average spectral efficiency gain of 12% at 50% per centile is observed. With 20 UEs per cell there is no observable gain.

The following options were considered with no convergence on which option to choose:
Option A: Keep 16 HARQ process IDs and rely on RLC ARQ for HARQ processes with UL HARQ feedback disabled via RRC
Option B: Greater than 16 HARQ process IDs with UL HARQ feedback enabled via RRC with following consideration. In this case, in the case of 16 or more HARQ process IDs, maintenance of a 4-bit HARQ process ID field in UE capability and DCI may be considered.

Alternatively, the following solutions may be considered for 16 or more HARQ processes keeping the 4-bit HARQ process ID field in DCI:
Option A: Keep 16 HARQ process IDs and rely on RLC ARQ for HARQ processes with UL HARQ feedback disabled via RRC
Option B: Greater than 16 HARQ process IDs with UL HARQ feedback enabled via RRC with following consideration. In this case, in the case of 16 or more HARQ process IDs, maintenance of a 4-bit HARQ process ID field in UE capability and DCI may be considered.

Alternatively, the following solutions may be considered for 16 or more HARQ processes keeping the 4-bit HARQ process ID field in DCI:
Slot number based
Virtual process ID based with HARQ re-transmission timing restrictions
Reuse HARQ process ID within RTD (time window)
Re-interpretation of existing DCI fields with assistance information from higher layers
One source also considered solutions where the HARQ process ID field is increased beyond 4 bits

With regards to HARQ enhancements for soft buffer management and stop-and-wait time reduction, the following options were considered with no convergence on which, if any, of the options, to choose:
Option A-1: Pre-active/pre-emptive HARQ to reduce stop-and-wait time
Option A-2: Enabling/disabling of HARQ buffer usage configurable on a per UE and per HARQ process
Option A-3: HARQ buffer status report from the UE

The number of HARQ processes with additional considerations for HARQ feedback, HARQ buffer size, RLC feedback, and RLC ARQ buffer size should be discussed further when specifications are developed.

The configurations (NR frame structure, NTN system, etc.) discussed above may be combined and applied in the contents described below, or may be supplemented to clarify the technical features of the methods proposed in the present disclosure. In addition, methods related to HARQ disabling, which will be described later, are related to UL transmission and may be equally applied to the DL signal transmission method in the NR system or LTE system described above. It is to be noted that terms, expressions, structures, and the like defined in each system may be appropriately modified or replaced so that the technical idea proposed in this specification can be implemented in the corresponding system.

### UL Power Control and BWP Operation in NTN

A UL power control and BWP operation method for effective UL transmission in a non-terrestrial network (NTN) will be described. The above-described FIG. 8 may be referenced and applied to information related to UL power control, and the premise content related to BWP may be referred to and/or applied to FIG. 4 described above. As described above, an NTN service provides a wireless communication service to UEs by installing BSs in places not located on the ground such as artificial satellites (geostationary orbit, low orbit, mid-orbit, etc.), airplanes, unmanned airships, drones, etc. instead of installing BSs on the ground.

Hereinafter, proposals 1 to 3 related to BWP and UL power control will be described in detail.

### (1) Proposal 1: Setting Power Control Parameters for Each BWP

UL power control parameters may be set for each BWP, and the UL power control parameters may be changed through switching of BWPs.

In detail, with regard to proposal 1, a UL power control parameter (or UL power control settings (e.g., Pcmax, alpha, P0, f, etc. in Equation 1 described above)) are differently set/applied depending on BWP, and in conjunction with (dynamic) BWP switching, the UL power control parameter may be dynamically changed and/or instructed.

In the current NR, up to four bandwidth parts (BWPs) may be set per specific CC, and one BWP among the four BWPs may be set as an active BWP. A plurality of BWPs may be set in a UE or the like to change a use case (e.g., eMBB, URLLC service, etc.) and/or numerology of the UE for each BWP.

In the case of NTN, since a satellite moves at a high speed over time (e.g., the satellite moves at about 7.6 km/s in the case of LEO 600 km), a large link (e.g., access link) distance change between the satellite and the UE may occur. In this case, a change in a serving satellite may cause a change in an access link or the like, and a change in UL power control may be required. In particular, in a transparent payload scenario in which a satellite serves as a relay between a via gate way (gNB) and a UE, the UE may not be aware of a change in the serving satellite. In this case, for proper UL transmission, a power control parameter change/instruction may be required, and the power control parameter may be efficiently changed in association with BWP switching.

For example, when a UL power control parameter is set in response to each BWP, the UE may change/update the UL power control parameter associated with the BWP to be changed (switched) based on the BWP switching instruction. When BWP1 is set to Pcmax=10 dBm, P0=−85 dBm, and alpha=1, and BWP2 is set to Pcmax=10 dBm, P0=−80 dBm, alpha=0.8, etc., the BWP may be changed or may be automatically changed (a power control parameter value corresponding to BWP 1 may be changed/updated to a power control parameter value corresponding to BWP 2) to be interlocked or linked with the UL power control parameter based on switching (e.g., changed to BWP 2 from BWP 1).

Here, Pcmax is the maximum permissible transmission power of the UE per carrier, P0 is target reception power of the BS (or satellite), and alpha is a fractional path-loss compensation parameter. Here, if alpha is 1, full path-loss compensation may be performed. In addition, f may be defined as shown in Table 9 below as a closed loop PC parameter indicated by a TPC field of the DCI. Here, f may be a cumulative value of δ_{PUSCH,b,f,c} or the same value thereof.

TABLE 9

| TPC Command | Accumulated δ_{PUSCH, b, f c} | Absolute δ_{PUSCH, b, f c} |
|---|---|---|
| Field | or δ_{SRS, b, f, c} [dB] [symbol] | or δ_{SRS, b, f, c} [dB] [symbol] |
| 0 [symbol] | −1 [symbol] | −4 [symbol] |
| 1 [symbol] | 0 [symbol] | −1 [symbol] |
| 2 [symbol] | 1 [symbol] | 1 [symbol] |
| 3 [symbol] | 3 [symbol] | 4 [symbol] |

### 1) Proposal 1-1: Enable/Disable Configuration of HARQ Feedback per BWP

Alternatively, when enabling/disabling of HARQ feedback is configured differently for each BWP, a corresponding power control parameter may be set for each BWP in consideration of whether the HARQ feedback is enabled/disabled for the BWP.

In detail, with regard to proposal 1-1, whether to enable/disable HARQ feedback for each BWP may be preset. BWP1 may be configured with only HARQ processes in which HARQ feedback is enabled, and BWP2 may be configured with only HARQ processes in which HARQ feedback is disabled. In this case, enabling/disabling of HARQ feedback may be interlocked or linked with BWP switching, and thus whether the BWP is changed and whether HARQ feedback is enabled/disabled may be dynamically changed and/or instructed.

Alternatively, when changing and/or switching from BWP2 to BWP 1, HARQ feedback may be changed from disabled to enabled. In this case, the HARQ-ACK codebook (e.g., Type 1/2/3) may be configured in consideration of only the BWP in which HARQ feedback is enabled, and parameter values associated therewith (e.g., parameters related to HARQ feedback) may be determined. An advantage of the above proposal is that it is possible to indicate and/or change enabling/disabling of (semi-static or dynamic) HARQ feedback without introducing separate signaling.

When HARQ feedback is enabled, appropriate MCS configuration based on HARQ feedback may be possible, and link reliability (DL and/or UL) may be smoothly maintained. Unlike this, when HARQ feedback is disabled, link reliability may be relatively degraded in that there is no feedback information. Considering this problem, UL PC (power control) may also be set differently in conjunction with enable/disable of HARQ feedback. In detail, enabling/disabling of HARQ feedback for each BWP may be interlocked, and a power control parameter for each BWP may be set or determined based on enabling/disabling of HARQ feedback linked for each BWP. That is, enabling/disabling of HARQ feedback may be different for each BWP, and the UL PC parameter set may also be instructed to be set differently, and may be dynamically changed according to a changed in BWP. In other words, proposal 1 and proposal 1-1 may be considered together, and whether or not HARQ feedback is enabled and power control parameters for each BWP may be interlocked or linked.

For example, when changing and/or switching from BWP 2 to BWP 1, i) HARQ feedback is changed from disabled to enabled, and ii) a value of a first PC parameter (corresponding to BWP 2) may be changed and/or updated to a value of a second PC parameter (which is set correspondingly to BWP 1).

### 2) Proposal 1-2: Beam Group or Beam Pool Setting for Each BWP.

In detail, according to proposal 1-2, a pool of serving beams (e.g., SSB, and CSI-RS) for each BWP may be tied (or linked). In this case, a beam pool (group) may be dynamically changed through BWP switching based on satellite motion. Alternatively, a beam pool may be dynamically changed through BWP switching corresponding to a change in the position of the satellite. And/or, a UL PC parameter set may also be configured differently for each BWP (or each beam pool). In other words, the UL power control parameter may be differently set or determined according to the BWP and the beam pool in the BWP.

In the proposal 1-2, a serving beam pool may be a group of beams for serving the UE or a group of UEs. In the case of NTN, even if a sharp beam is used in a satellite, the range of a receiving UE on the ground may be inevitably wider than that of a general terrestrial network (TN). Considering this point, in the case of NTN, specific beams may be grouped for each BWP to perform beam sweeping with a number smaller than the number of serving beams for TN It may be more advantageous than sweeping a large number of serving beams (e.g., 64 SSBs) like TN. Here, the beam or beam group may be alternatively used as a term of a panel. The serving beam may be defined or expressed in correspondence with spatial relation RS/QCL related RS.

### (2) Proposal 2 — Power Control Based on Satellite Orbit Information

The UL power control parameter may be set as a series of a plurality of power control parameter values (or a series of a plurality of power control parameter sets) to be sequentially applied based on satellite information such as satellite orbit information. In this case, the UE may determine which UL power control parameter (or UL PC parameter) to apply at a specific time point (through GNSS, etc.) and may use it for UL transmission.

In detail, as a timing applied by the UE, information on an application start time and update timing of a plurality of transmitted UL power control parameters may be promised or preset. In other words, application timing information corresponding to each UL power control parameter (or UL PC parameter set) may be predefined or set/instructed together with the UL power control setting (or UL PC parameter set). Alternatively, the UE may autonomously perform update by utilizing satellite orbit information of a serving satellite or NTN. Whether or not to support the autonomous power control of the UE may be determined according to the capability of the UE. The UE may determine which power control parameter (or power control parameter set) to apply at a specific time point corresponding to itself (through GNSS, etc.) based on the power control parameter set, and may perform UL transmission based on the determined power control parameter.

Alternatively, as the UL power control parameters (e.g., Pcmax, alpha, P0, f, etc.), a plurality of UL power control parameters (or a plurality of power control parameter sets) to be sequentially applied by the UE in consideration of satellite orbit information (e.g., velocity, position, and time) may be preset or defined as a series. In this case, the UE may determine which UL power control parameter (PC parameter) to apply at a specific time point (through GNSS, etc.) and may then perform UL transmission according to the determined UL PC parameter.

For example, a satellite orbit range may be divided into stages, and a power control parameter (UL PC parameter) corresponding to each stage may be set/defined. In this case, the UE may transmit UL data by identifying orbit information of the satellite and applying the power control parameter (UL PC parameter) of the corresponding stage. In other words, the range of the satellite orbit corresponding to each of the plurality of power control parameter sets may be preconfigured, and the BS may inform the UE of a mapping relationship between the plurality of power control parameter sets and satellite orbit ranges in advance. In this case, the UE may determine a satellite orbit range currently corresponding to itself among the plurality of satellite orbit ranges based on the satellite orbit information (or a satellite orbit range in which a satellite, which is the BS, is located), and may determine transmission power of UL transmission by applying the transmission power parameter corresponding to the determined satellite orbit range.

Here, the UL power control parameter (or UL power control parameter set) may correspond to at least one or more parameters (e.g., Pcmax, alpha, P0, f, etc. related to Equation 1) to be applied at a predetermined time point, and for convenience of description, the UL power control parameter may be defined as the UL power control setting applied at the one time point.

That is, the UE may receive configuration information including information on the plurality of power control settings from the BS. The UE may additionally obtain information on a time or points in time at which each of the plurality of power control settings is applied from the configuration information, and may change or update a corresponding power control setting at each of the times. Alternatively, the UE may determine a power control setting corresponding to the satellite orbit information from among the plurality of power control settings, or may update the power control setting within the plurality of power control settings based on the satellite orbit information.

Alternatively, an objective of UL power control includes an objective of appropriately controlling interferences caused by a UL signal transmitted by the UE as well as an objective of receiving a signal, transmitted by the UE, by the BS in consideration of path-loss without a problem.

In this respect, a serving satellite and a TN coexisting within a coverage radius of the serving satellite may reduce transmission power of UL when there is a risk of interference with each other, or when there is a lot of specific traffic, muting may be requested. In detail, when the UE communicating with a satellite causes strong interference to the TN, the TN may report information on the interference from the UE to the gNB of the NTN, and may lower the UL transmit power of the UE, or may request muting at a time of high traffic.

Alternatively, when satellites having the same zenith angle or a zenith angle difference within a specific threshold range coexist, although there is a difference in altitude from the serving satellite, the coexisting satellite or the gNB controlling the coexisting satellite may request the serving satellite to adjust or mute the UL transmit power of the UE related to the serving cell. In other words, the coexisting satellite or the gNB controlling the satellite may request the BS connected to the UE to adjust or mute the UL transmission power of the corresponding UE. Alternatively, as described above, a plurality of UL power control settings may be configured in the UE, and the UE may autonomously control UL power based on the plurality of UL power control settings. In other words, when interference with the coexisting satellite occurs, the UE may control the UL transmission power based on the UL power control settings corresponding to the occurrence of interference due to the coexistence of another satellite among the plurality of UL power control settings.

### (3) Proposal 3: UL Transmission Power Control for Each UE Group

UL transmission power control may be performed for each UE group. Here, a plurality of UEs may be grouped based on a beam and/or BWP related to a satellite of the NTN.

In detail, with regard to proposal 3, since a distance between the UE and the satellite in the NTN is much longer than a distance between UEs, a value of free-space path loss may have an almost similar value for one beam, and thus (closed-loop) power control may be performed for all UEs serving the one beam or for each specific group.

In the NTN, a range covered by one beam is wide, and the number of UEs within this range may be much larger than that of TNs. Therefore, when power control is performed for each UE, a considerable amount of overhead for the NTN may occur. This overhead problem may be overcome through power control for each group according to the above-described proposal 3. Alternatively, when the same (closed-loop) power control is performed on all UEs within a beam covered by one satellite, it may be inefficient in consideration of a beam size (e.g., 50 km). Accordingly, it may be possible to perform (closed-loop) power control for each group of UEs covered by one beam as a specific group. In order to effectively utilize such grouping, a method of mapping a specific UE group to a specific BWP may be used. For example, UEs set to the same active BWP (and/or operating in the same active BWP) may be grouped, and (closed-loop) power control may be performed in units of UE groups. In other words, when a plurality of BWPs are configured within one beam, a group for power control of a plurality of UEs related to the one beam may be determined according to a corresponding BWP.

Since examples of the above-described proposal method may also be included in one of implementation methods of the various embodiments of the present disclosure, it is obvious that the examples are regarded as a sort of proposed methods. Although the above-proposed methods may be independently implemented, the proposed methods may be implemented in a combined (aggregated) form of a part of the proposed methods. A rule may be defined such that the BS informs the UE of information as to whether the proposed methods are applied (or information about rules of the proposed methods) through a predefined signal (e.g., a physical layer signal or a higher-layer signal). The high layer may include, for example, one or more of functional layers such as MAC, RLC, PDCP, RRC, and SDAP.

Methods, embodiments, or descriptions for implementing the method proposed in this specification (e.g., proposal 1/proposal 2/proposal 3, etc.) may be separately applied or one or more methods (or embodiments or descriptions) may be applied in combination.

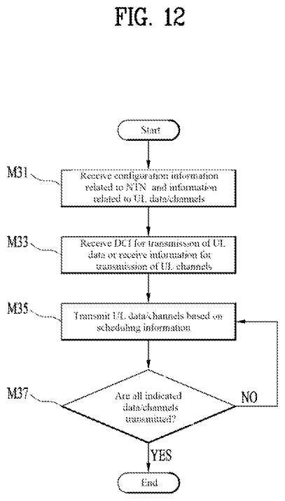

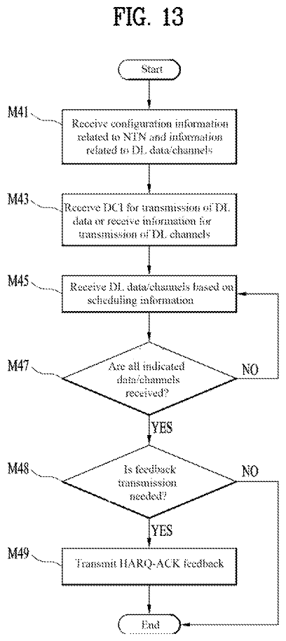

FIG. 12 is a flowchart illustrating a method for a UE to perform a UL transmission operation based on the above-described embodiments, and FIG. 13 is a flowchart illustrating a method for a UE to perform a DL reception operation based on the above-described embodiments.

The UE may perform NR NTN or LTE NTN transmission and reception of one or more physical channels/signals based on at least one of proposals 1, 2 and 3 described above. Meanwhile, at least one step shown in FIGS. 12 and 13 may be omitted depending on circumstances or settings, and the steps shown in FIGS. 12 and 13 are only described for convenience of description and do not limit the scope of the present specification.

Referring to FIG. 12, the UE may receive configuration information related to an NTN and information related to UL data/UL channels (M31). Next, the UE may receive DCI/control information for transmission of the UL data and/or UL channels (M33). The DCI/control information may include scheduling information for transmission of the UL data/UL channels. Next, the UE may transmit the UL data/UL channels based on the scheduling information (M35). The UE may transmit the UL data/UL channels until all configured/indicated UL data/UL channels are transmitted. When all the UL data/UL channels are transmitted, the corresponding UL transmission operation may be ended (M37).

Referring to FIG. 13, the UE may receive configuration information related to an NTN and information related to DL data and/or DL channels (M41). Next, the UE may receive DCI/control information for reception of the DL data and/or the DL channels (M43). The DCI/control information may include scheduling information of the DL data/DL channels. The UE may receive the DL data/DL channels based on the scheduling information (M45). The UE may receive the DL data/DL channels until all configured/indicated DL data/DL channels are received, and when all DL data/DL channels are received, the UE may determine whether transmission of feedback information for the received DL data/DL channels is needed (M47 and M48). If it is necessary to transmit the feedback information, the UE may transmit HARQ-ACK feedback and, if not, the UE may end the reception operation without transmitting HARQ-ACK feedback (M49).

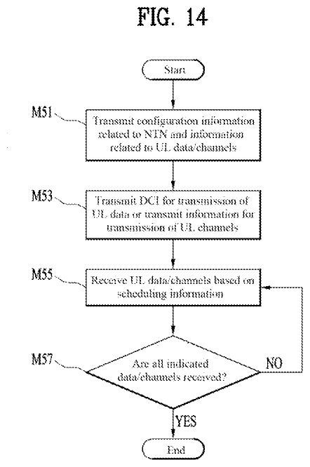

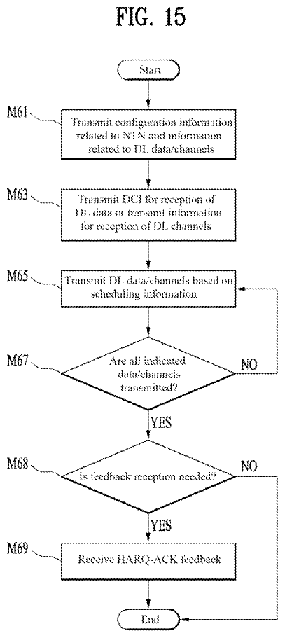

FIG. 14 is a flowchart illustrating a method for a BS to perform a UL reception operation based on the above-described embodiments, and FIG. 15 is a flowchart illustrating a method for a BS to perform a DL transmission operation based on the above-described embodiments.

The base station may perform NR NTN or LTE NTN transmission and reception of one or more physical channels/signals based on at least one of proposals 1, 2, and 3 described above. Meanwhile, at least one step shown in FIGS. 14 and 15 may be omitted depending on circumstances or settings, and the steps shown in FIGS. 14 and 15 are only described for convenience of description and do not limit the scope of the present specification.

Referring to FIG. 14, the BS may transmit configuration information related to an NTN and information related to UL data/UL channels to the UE (M51). Next, the BS may transmit DCI/control information for transmission of the UL data and/or UL channels (to the UE) (M53). The DCI/control information may include scheduling information for transmission of the UL data/UL channels. Next, the BS may receive the UL data/UL channels (from the UE) based on the scheduling information (M55). The BS may receive the UL data/UL channels until all configured/indicated UL data/UL channels are received. When all the UL data/UL channels are received, the corresponding UL reception operation may be ended (M57).

Referring to FIG. 15, the gNB may transmit configuration information related to an NTN and information related to DL data and/or DL channels (to the UE) (M61). Next, the BS may transmit DCI/control information for reception of the DL data and/or DL channels (M63). The DCI/control information may include scheduling information of the DL data/DL channels. The BS may transmit the DL data/DL channels (to the UE) based on the scheduling information (M65). The BS may transmit the DL data/DL channels until all configured/indicated DL data/DL channels are transmitted, and when all DL data/DL channels are transmitted, the BS may determine whether reception of feedback information for the DL data/DL channels is needed (M67 and M68). If it is necessary to receive the feedback information, the BS may receive HARQ-ACK feedback and, if not, the BS may end the DL transmission operation without receiving HARQ-ACK feedback (M69).

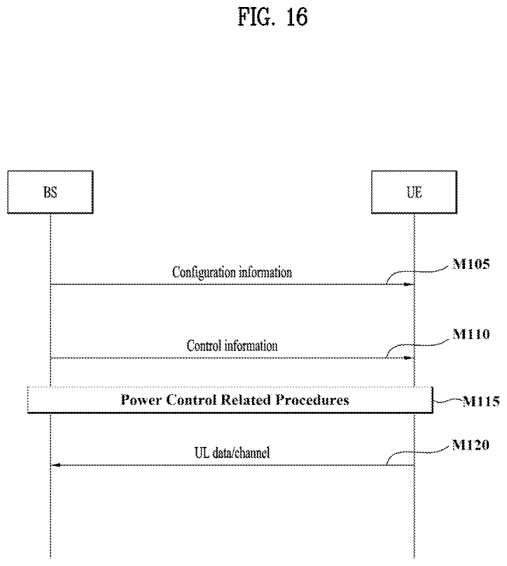

FIG. 16 is a diagram for explaining an operation of transmitting and receiving a UL channel between a terminal and a base station.

Although not shown in FIG. 16, a default HARQ operation mode of the UE may be set in a step prior to RRC connection/configuration. For example, when it is indicated through a PBCH (M113) or an SIB that (the cell accessed by the UE) is an NTN cell, the UE may recognize that the default mode is set to HARQ-disabled. For example, one of HARQ-disabled configuration and HARQ-enabled configuration(s) may be indicated as the default operation mode through the PBCH (MIB) or the SIB (e.g., when indicated as the NTN cell).

In addition, the UE may report capability information of the UE related to the above-described proposed method (e.g., proposal 1/proposal 2/proposal 3, etc.) to the BS. For example, the capability information of the UE may be reported periodically/semi-persistent/aperiodically. The BS may set/instruct operations described below based on the capability information of the UE. Here, the UE capability information relates to transmit/receive capabilities to be supported by the UE, and may include the number of recommended HARQ processes, information on whether it is possible to update the autonomous power control parameter based on satellite orbit information, and the like.

The BS may transmit configuration information to the UE (M105). That is, the UE may receive the configuration information from the BS. For example, the configuration information may include the NTN-related configuration information described in the above-described proposed methods (e.g., proposal 1/proposal 2/proposal 3)/configuration information for UL transmission and reception (e.g., PUCCH-config/ PUSCH-config)/HARQ process-related configuration (e.g., whether to enable/disable HARQ feedback/the number of HARQ processes/HARQ process ID)/CSI report-related configuration (e.g., CSI report config/CSI report quantity/CSI-RS resource config). For example, the configuration information may be transmitted through higher layer (e.g., RRC or MAC CE) signaling. For example, whether to enable/disable HARQ feedback may be configured for each cell group. For example, whether to enable/disable HARQ feedback may be configured through information in a bitmap format.

Alternatively, the configuration information may include UL power control-related configuration/BWP-related configuration/NTN satellite-related information (e.g., satellite orbit information), and the like. For example, as described in the above-mentioned proposed methods (e.g., proposal 1/proposal 2/proposal 3), UL power control related configuration (e.g., PC parameter)/HARQ process enabler/serving beam pool configuration may be configured in response to the BWP, etc. For example, BWP switching/change may be instructed/configured based on the configuration information.

Next, the BS may transmit the configuration information to the UE (M110). That is, the UE may receive the configuration information from the BS. For example, the configuration information may be transmitted/received through DCI. Alternatively, the configuration information may include control information for UL data/UL channel transmission and reception, scheduling information, resource allocation information, HARQ feedback-related information (e.g., an NDI, an RV, HARQ process number, a DL assignment index, a TPC command for a scheduled PUCCH resource indicator, and/or a PDSCH-to-HARQ FEEDBACK timing indicator), a modulation and coding scheme (MCS), and frequency domain resource assignment. Here, the DCI may be one of DCI format 1_0 and DCI format 1_1. Alternatively, the HARQ feedback-related information may be included in fields of the DCI.

Alternatively, as described above in the above proposed methods (e.g. proposal 1/proposal 2/proposal 3), whether to enable/disable HARQ feedback may also be configured based on the DCI. BWP switching/change may be instructed/configured based on the DCI. The DCI may include serving beam information. The DCI may information indicating a BWP to be used to receive data by the UE. That is, the BS may instruct or configure a BWP (that is, active BWP) to be used to transmit and receive data by the UE. As described in the above bandwidth part (BWP), the DCI may include a field indicating a specific DL BWP (that is, active DL BWP). In this case, the UE receiving the corresponding DCI may be configured to transmit UL data/channel in the active DL BWP indicated by the DCI.

The UE may perform power control-related procedures with the BS (M115). For example, the power control-related procedure may be performed based on the above-described proposed methods (e.g., proposal 1/proposal 2/proposal 3) and/or the UL power control described with reference to FIG. 8. Alternatively, the power control-related procedure may be performed based on information (e.g., a power control parameter or a power control setting) received through the configuration information/control information. Alternatively, when the BWP is switched, the power control-related procedure may be performed based on the power control setting corresponding to the changed BWP. Alternatively, power control may be performed based on satellite orbit information in the NTN. Alternatively, the power control-related procedure may be performed for all UEs serving a specific beam or for each group in the NTN.

The BS may receive the UL data/channel (e.g., PUCCH/PUSCH) from the UE (M120). That is, the UE may transmit the UL data/channel to the BS. For example, the UL data/channel may be received/transmitted based on the above-described configuration information/control information, etc. Alternatively, the UL data/channel may be received/transmitted based on the above-described proposed method (e.g., proposal 1/proposal 2/proposal 3). The UL data/channel may be transmitted based on the transmission power determined based on step M115.

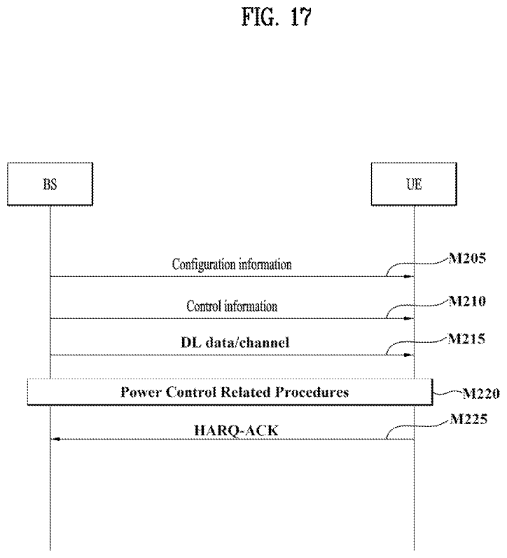

FIG. 17 is a diagram for explaining transmission/reception of DL data and/or channels between a terminal and a base station.

Although not shown in FIG. 17, the default HARQ operation mode of the UE may be configured in a step prior to RRC connection/configuration. For example, when it is indicated through PBCH (MIB) or SIB that (the cell accessed by the UE) is an NTN cell, the UE may recognize that the default mode is configured to HARQ-disabled. For example, the BS may indicate one of the HARQ-disabled configuration and the HARQ-enabled configuration(s) as the default operation mode through the PBCH (M113) or the SIB (e.g., when indicated as an NTN cell).

The UE may report capability information of the UE related to the above-described proposed method (e.g., proposal 1/proposal 2/proposal 3) to the BS. For example, the UE capability information may be reported periodically/semi-persistent/aperiodically. The BS may configure/instruct operations to be described below in consideration of the capabilities of the UE. Here, the UE capability information relates to transmit/receive capabilities to be supported by the UE, and may include the number of recommended HARQ processes, information on whether it is possible to update the autonomous power control parameter based on satellite orbit information, and the like.

The BS may transmit the configuration information to the UE (M205). That is, the UE may receive the configuration information from the BS. For example, the configuration information may include the NTN-related configuration information described in the above-described proposed methods (e.g., proposal 1/proposal 2/proposal 3)/configuration information for UL transmission and reception (e.g., PUCCH-config/PUSCH-config)/HARQ process process-related configuration (e.g., whether to enable/disable HARQ feedback/the number of HARQ processes/HARQ process ID)/CSI report-related configuration (e.g., CSI report config/CSI report quantity/CSI-RS resource config). For example, the configuration information may be transmitted through higher layer (e.g., RRC or MAC CE) signaling. For example, whether to enable/disable HARQ feedback may be configured for each cell group. For example, whether to enable/disable HARQ feedback may be configured through information in a bitmap format.

For example, the configuration information may include UL power control-related configuration/BWP-related configuration/NTN satellite-related information (e.g., satellite orbit information), and the like. As described in the above-mentioned proposed methods (e.g., proposal 1/proposal 2/proposal 3), UL power control related configuration (e.g., PC parameter)/HARQ process enabler/serving beam pool configuration may be configured in response to the BWP, etc. For example, BWP switching/change may be instructed/configured based on the configuration information.

The BS may transmit the configuration information to the UE (M210). That is, the UE may receive the configuration information from the BS. The configuration information may be transmitted/received through DCI. Alternatively, the configuration information may include control information for DL data/DL channel transmission and reception, scheduling information, resource allocation information, HARQ feedback-related information (e.g., an NDI, an RV, HARQ process number, a DL assignment index, a TPC command for a scheduled PUCCH resource indicator, and/or a PDSCH-to-HARQ FEEDBACK timing indicator), an MCS, and frequency domain resource assignment. The DCI may be one of DCI format 1_0 and DCI format 1_1.

For example, as described in the above-described proposed methods (e.g., proposal 1/proposal 2/proposal 3), whether to enable/disable HARQ feedback may be configured based on the DCI. Alternatively, BWP switching/change may be instructed/configured based on the DCI. For example, the DCI may include serving beam information. Alternatively, the DCI may include information indicating a BWP to be used by the UE for data reception. That is, the BS may indicate or configure a BWP (i.e., active BWP) to be used by the UE for data transmission and reception. For example, as mentioned in the above-mentioned bandwidth part (BWP), the DCI may include a field indicating a specific DL BWP (i.e., active DL BWP). In this case, the UE receiving the corresponding DCI may be configured to receive DL data/channel in an active DL BWP indicated by the DCI.

The BS may transmit the DL data/channel (e.g., PDSCH) to the UE (M215). That is, the UE may receive the DL data/channel from the BS. For example, the DL data/channel may be transmitted/received based on the above-described configuration information/control information, etc. Alternatively, the DL data/channel may be transmitted/received based on the above-described proposed method (e.g., proposal 1/proposal 2/proposal 3).

The UE may perform power control-related procedures with the BS (M220). For example, the power control-related procedure may be performed based on the above-described proposed methods (e.g., proposal 1/proposal 2/proposal 3) and/or the UL power control described with reference to FIG. 8. Alternatively, the power control-related procedure may be performed based on information (e.g., a power control parameter or a power control setting) received through the configuration information/control information. Alternatively, when the BWP is switched, the power control-related procedure may be performed based on the power control setting corresponding to the changed BWP. Alternatively, power control may be performed based on satellite orbit information in the NTN. Alternatively, the power control-related procedure may be performed for all UEs serving a specific beam or for each group in the NTN.

The BS may receive the HARQ-ACK feedback from the UE (M225). That is, the UE may transmit the HARQ-ACK feedback to the BS. Alternatively, the HARQ-ACK feedback may be enabled/disabled. Alternatively, when the HARQ-ACK feedback is enabled, the HARQ-ACK feedback may be transmitted/received. The HARQ-ACK feedback may include ACK/NACK information for the DL channel/data transmitted from the BS. The HARQ-ACK feedback may be transmitted through a PUCCH and/or a PUSCH. The HARQ-ACK feedback may be transmitted based on transmission power determined based on the above-described proposed method (e.g., proposal 1/proposal 2/proposal 3).

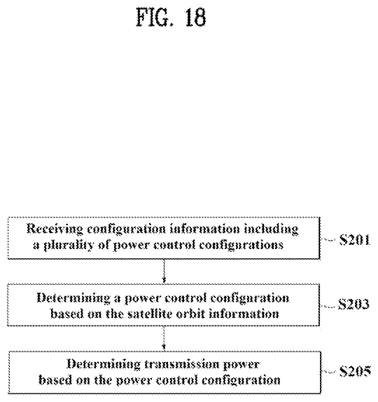

FIG. 18 is a flowchart for explaining a method of determining transmission power of a UL signal by a UE.

Referring to FIG. 18, the UE may receive configuration information related to transmission power of the UL signal from the NTN (S201). The configuration information may include information on a plurality of power control settings or may include information on BWP indexes for indirectly indicating the plurality of power control settings (e.g., information on BWP indexes for sequential BWP switching).

Here, the power control setting may be configuration information for parameters for controlling transmission of uplink (UL) and may be a configuration for configuring a value of at least one parameter related to Equation 1 above. As described above, the power control setting may correspond to the above-described UL power control parameter and UL power control parameter set.

Alternatively, the configuration information may include satellite orbit information related to the NTN or the satellite orbit information may be signaled separately. The satellite orbit information may be used to estimate the position of the satellite of the NTN. For example, the satellite orbit information may include information for estimating the position of the satellite NTN, such as the satellite orbit, a moving direction of the satellite, a moving speed of the satellite, and the position of the satellite on orbit by time.

Alternatively, the configuration information may further include information on locations of the plurality of NTNs, and each of the plurality of power control settings may be preconfigured to correspond to each location of the NTN (i.e., the positions of the plurality of NTNs and the plurality of power control settings are preconfigured to correspond one-to-one). Alternatively, the configuration information may further include information on satellite orbit ranges corresponding to the plurality of power control settings.

Alternatively, the configuration information may include information about times corresponding to the plurality of power control settings, respectively. In detail, the configuration information may include information on a start time at which application of the plurality of power control settings starts, and information about change times at which the plurality of power control settings is sequentially applied or changed. For example, when the plurality of power control settings include a first power control setting and a second power control setting, information about when the first power control setting is applied and when the first power control setting is changed to the second power control setting (alternatively, when the second power control setting is applied) may be included.

Then, the UE may determine one power control setting among the plurality of power control settings based on the satellite orbit information (S203).

For example, the UE may estimate the NTN or the location of a platform related to the NTN based on the satellite orbit information, and may determine a first power control setting corresponding to the location of the estimated NTN (or the platform related to the NTN) among the plurality of power control settings based on the location of the estimated NTN (or the platform related to the NTN) and/or the location of the UE (acquired according to a GNSS or the like).

Here, the platform related to the NTN may be an artificial satellite performing NTN communication and may correspond to at least one of GEO (Geostationary orbit) satellite, MEO (Medium-Earth Orbit) satellite, REO (High Elliptical Orbit) satellite, HAPS (High Altitude Platform Station), or LEO (Low earth Orbit) satellite.

Alternatively, the configuration information may further include information about the locations of the plurality of NTN (or platform related to NTN) corresponding to each of the plurality of power control settings. In this case, the UE may estimate the location of the NTN (or the platform related to the NTN) based on the satellite orbit information, and may determine one power control setting (or first power control setting) corresponding to the location of the estimated NTN among the plurality of power control settings. In addition, when the location of the NTN is changed based on the satellite orbit information, the UE may determine another power control setting (or second power control setting) corresponding to the changed location of the NTN (or the platform related to the NTN) among the plurality of power control settings and may change or update one existing power control setting to the other power control setting. In this case, the UE may determine transmission power of the UL signal based on the changed power control setting.

The configuration information may further include information on satellite orbit ranges corresponding to the plurality of power control settings. In this case, the UE may estimate or determine the satellite orbit range in which the NTN (or the platform related to the NTN) among the plurality of satellite orbit ranges is positioned based on the satellite orbit information. The UE may determine one power control setting (or first power control setting) corresponding to the satellite orbit range of the estimated NTN (or the platform related to the NTN) among the plurality of power control settings. In addition, when the satellite orbit range in which the NTN (or the platform related to the NTN) is positioned is changed based on the satellite orbit information, the UE may change or update the one power control setting to a power control setting corresponding to the changed satellite orbit range among the plurality of power control settings. As such, the UE may sequentially apply or update each of the plurality of power control settings depending on the location of the NTN (or the platform related to the NTN) estimated based on the satellite orbit information.

The configuration information may include information on times corresponding to the plurality of power control settings, respectively. In this case, the UE may sequentially apply each of the plurality of power control settings according to time based on the information about the times.

Then, the UE may determine transmission power of the UL signal based on the determined power control setting (S205). As described above, the UE may acquire a value for at least one parameter related to Equation 1 from the determined power control setting, and may determine the transmission power of the UL signal by applying the value of the at least one parameter to Equation 1 above.

Alternatively, the plurality of power control settings may be preconfigured to correspond one-to-one to the plurality of BWP indexes. In this case, the UE may transmit the UL signal according to the first power control setting through BWP switching with a BWP having a BWP index corresponding to the first power control setting among the plurality of BWP indexes.

As such, the UE may sequentially determine or apply one power control setting among the plurality of power control settings based on the location of the estimated NTN (or the platform related to the NTN) based on the satellite orbit information. That is, the UE may determine or select a required power control setting based on the satellite orbit information among the plurality of pre-transferred power control settings, thereby overcoming the disadvantage of the NTN communication system having a long RTT.

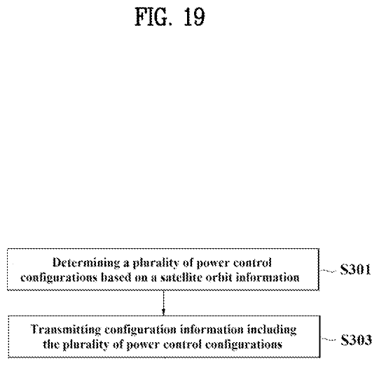

FIG. 19 is a flowchart for explaining a method of controlling transmission power of a UE by an NTN.

Referring to FIG. 19, the NTN may determine a plurality of power control settings based on satellite orbit information related to the NTN. For example, the NTN may predict the location of the NTN (or the platform related to NTN) on the orbit for each time zone according to the satellite orbit information, and may determine the corresponding power control setting in consideration of a distance with UEs depending on the predicted location of the NTN (the platform related to NTN).

Alternatively, the NTN may determine the locations of the NTN (or the platform related to the NTN) requiring a change in the power control setting based on the satellite orbit information, and may determine the power control setting to be changed or updated at each determined location of the NTN (or the platform related to the NTN). That is, the NTN may determine the locations of the plurality of NTNs (or the platform related to NTNs) requiring a change in the power control setting based on the satellite orbit information, and may pre-determine and configure the power control setting corresponding to the respective determined locations of the plurality of NTNs (or the platform related to the NTN). In other words, the NTN may previously configure or determine a one-to-one mapping relationship between locations of the plurality of NTNs (or the platforms related to the NTN) and a plurality of power control settings. The mapping relationship may be included in the configuration information and delivered to the UE, or may be previously transmitted to the UE through separate signaling.

Alternatively, the NTN may configure a satellite orbit range in which one power control setting is to be maintained based on the satellite orbit information, and may determine a corresponding power control setting for each satellite orbit range. That is, the NTN may previously configure or determine a one-to-one mapping relationship between a plurality of orbit ranges and a plurality of power control settings. The mapping relationship may be included in the configuration information and transferred to the UE, or may be previously transmitted to the UE through separate signaling.

Alternatively, the NTN may determine the times at which a power control setting needs to be changed or applied based on the location thereof (or the platform related to the NTN) predicted based on the satellite orbit information, and may determine the corresponding power control setting for each determined time. That is, the NTN may determine a plurality of times at which a power control setting needs to be changed or applied, and determine a power control setting corresponding to each time. In other words, the NTN may predict locations thereof and times based on the satellite orbit information, and may determine appropriate power control settings corresponding to the predicted locations and times.

Then, the NTN may transmit configuration information including the plurality of power control settings to the UE (S303). Alternatively, the NTN may transmit satellite orbit information related thereto to the UE via the configuration information or separate signaling.

Alternatively, the NTN may transmit information on the locations of the NTN (or the platform related to the NTN) corresponding to each of the plurality of power control settings and the configuration information including the plurality of power control settings. In this case, the UE may estimate the current location of the NTN (or the platform related to the NTN) based on the satellite orbit information, and may determine the corresponding power control setting based on the estimated location or may update or change the existing power control setting to the corresponding power control setting. In this case, the UE may change the existing power control setting to the power control setting corresponding to the location of the NTN (or the platform related to NTN), and may sequentially apply each of the plurality of power control settings depending on a change in the location of the NTN (or the platform related to NTN).

Alternatively, the NTN may transmit information on a plurality of orbit ranges corresponding to each of the plurality of power control settings and the configuration information including the plurality of power control settings. In this case, the UE may estimate or predict the orbit range in which the NTN is currently located among the plurality of orbit ranges based on the satellite orbit information, and may determine the power control setting corresponding to the estimated or predicted orbit range or may update or update the existing power control setting to the corresponding power control setting.

Alternatively, the NTN may transmit the configuration information further including information on a start point at which application of the plurality of power control settings starts and/or information on a change point at which a change to each power control setting is required. In this case, the UE may determine a power control setting corresponding to the current time based on information on a point in time or times corresponding to a plurality of power control settings, or may update or change the existing power control setting to the corresponding power control setting.

The configuration information including information on a plurality of orbit ranges corresponding to each other and the plurality of power control settings may be transmitted.

As such, the NTN may predict a change in the location thereof based on the satellite orbit information in advance, may configure a plurality of appropriate power control settings in advance based on the predicted position change, and may previously transfer or transmit the plurality of preconfigured power control settings to the UE to overcome a delay problem of power control according to the long RTT.

Alternatively, the plurality of power control settings may be configured in advance to correspond one-to-one with a plurality of BWP indexes. In this case, the NTN may instruct the UE to change to the corresponding power control setting indirectly by instructing a switch to the corresponding BWP instead of directly instructing the UE of the plurality of power control settings.

### Communication System Example to which the Present Disclosure is Applied

Although not limited thereto, various descriptions, functions, procedures, proposals, methods, and/or operational flow charts of the present disclosure disclosed in this document may be applied to various fields requiring wireless communication/connection (5G) between devices.

Hereinafter, it will be illustrated in more detail with reference to the drawings. In the following drawings/description, the same reference numerals may exemplify the same or corresponding hardware blocks, software blocks, or functional blocks, unless otherwise indicated.

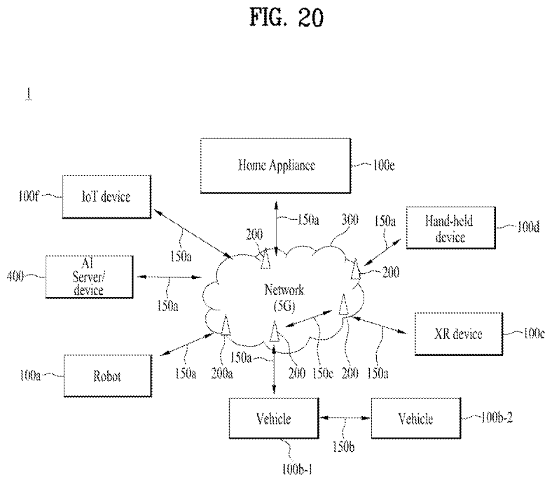

FIG. 20 illustrates a communication system applied to the present disclosure.

Referring to FIG. 20, a communication system 1 applied to the present disclosure includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an eXtended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous driving vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

### Examples of Wireless Devices to which the Present Disclosure is Applied

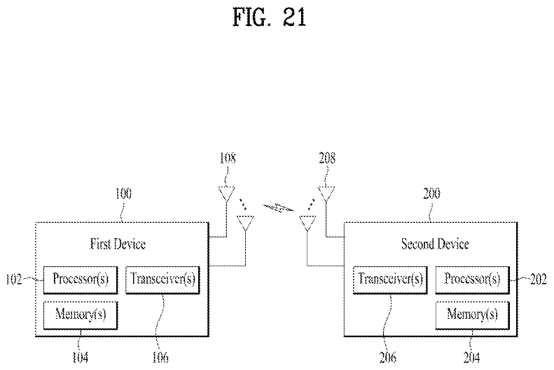

FIG. 21 illustrates a wireless device applicable to the present disclosure.

Referring to FIG. 21, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 20.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information acquired by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

For example, the first wireless device 100 or the UE may include the processor 102 and the memory 104 connected to the RF transceiver. The memory 104 may include at least one program for performing an operation related to the embodiments described in FIGS. 13 to 24.

In detail, the processor 102 may control the RF transceiver 106 to receive configuration information including information related to a plurality of power control settings from a non-terrestrial network (NTN), may determine a first power control setting among the plurality of power control settings based on satellite orbit information related to the NTN, and may determine the transmission power based on the first power control setting.

Alternatively, a chip set including the processor 102 and the memory 104 may be configured. In this case, the chip set may include at least one processor and at least one memory operatively connected to the at least one processor and configured to cause the at least one processor to perform an operation when being executed, and the operation may include receiving configuration information including information related to a plurality of power control settings from a non-terrestrial network (NTN), determining a first power control setting among the plurality of power control settings based on the satellite orbit information related to the NTN, and determining the transmission power based on the first power control setting. In addition, the at least one processor may perform operations for the embodiments described in FIGS. 9 to 19 based on the program included in the memory.

A computer readable storage medium including at least one computer program that causes the at least one processor to perform an operation may be provided, and the operation may include receiving configuration information including information related to a plurality of power control settings from a non-terrestrial network (NTN), determining a first power control setting among the plurality of power control settings based on the satellite orbit information related to the NTN, and determining the transmission power based on the first power control setting. In addition, the computer program may include programs for performing operations for the embodiments described in FIGS. 9 to 19.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information acquired by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

The BS or the NTN may include the processor 202, the memory 204, and/or the transceiver 206.

The processor may control the processor 202 or the RF transceiver 206 to determine a plurality of power control settings based on satellite orbit information related to the NTN and control the RF transceiver to transmit configuration information for the plurality of power control settings to the UE, and for each of the plurality of power control settings, corresponding position information of the NTN may be configured in advance. The processor 202 may perform the above-described operations based on the memory 204 including at least one program for performing operations related to the embodiments described in FIGS. 9 to 19.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

### Examples of Application of Wireless Devices to which the Present Invention is Applied

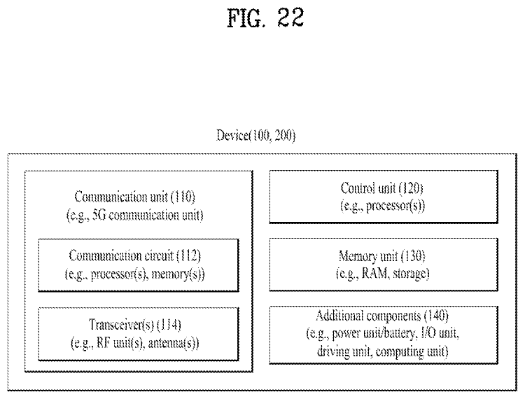

FIG. 22 illustrates another example of a wireless device applied to the present disclosure.

Referring to FIG. 22, wireless devices 100 and 200 may correspond to the wireless devices 100 and 200 of FIG. 21 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 21. For example, the transceiver(s) 114 may include the one or more transceivers 106 and 206 and/or the one or more antennas 108 and 208 of FIG. 21. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 20), the vehicles (100b-1 and 100b-2 of FIG. 20), the XR device (100c of FIG. 20), the hand-held device (100d of FIG. 20), the home appliance (100e of FIG. 20), the IoT device (100f of FIG. 20), a digital broadcast terminal, a hologram device, a public safety device, an MTC device, a medicine device, a fintech device (or a finance device), a security device, a climate/environment device, the AI server/device (400 of FIG. 20), the BSs (200 of FIG. 20), a network node, etc. The wireless device may be used in a mobile or fixed place according to a use-example/service.

In FIG. 22, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

Here, wireless communication technologies implemented in the wireless devices (XXX, YYY) of the present specification may include LTE, NR, and 6G, as well as Narrowband Internet of Things for low power communication. At this time, for example, the NB-IoT technology may be an example of a Low Power Wide Area Network (LPWAN) technology, and may be implemented in standards such as LTE Cat NB1 and/or LTE Cat NB2, and is not limited to the above-described names. Additionally or alternatively, the wireless communication technology implemented in the wireless devices (XXX, YYY) of the present specification may perform communication based on LTE-M technology. In this case, as an example, the LTE-M technology may be an example of LPWAN technology, and may be referred to by various names such as eMTC (enhanced machine type communication). For example, LTE-M technology may be implemented in at least one of a variety of standards, such as 1) LTE CAT 0, 2) LTE Cat M1, 3) LTE Cat M2, 4) LTE non-BL (non-Bandwidth Limited), 5) LTE-MTC, 6) LTE Machine Type Communication, and/or 7) LTE M, and is not limited to the above-described names. Additionally or alternatively, the wireless communication technology implemented in the wireless devices (XXX, YYY) of the present specification is at least one of ZigBee, Bluetooth, and Low Power Wide Area Network (LPWAN) considering low power communication, and is not limited to the above-described names. As an example, ZigBee technology can generate personal area networks (PANs) related to small/low-power digital communication based on various standards such as IEEE 802.15.4, and may be called various names.

The embodiments described above are those in which components and features of the present disclosure are combined in a predetermined form. Each component or feature should be considered optional unless explicitly stated otherwise. Each component or feature may be implemented in a form that is not combined with other components or features. In addition, it is also possible to constitute an embodiment of the present disclosure by combining some components and/or features. The order of operations described in the embodiments of the present disclosure may be changed. Some configurations or features of one embodiment may be included in other embodiments, or may be replaced with corresponding configurations or features of other embodiments. It is obvious that the embodiments may be configured by combining claims that do not have an explicit citation relationship in the claims or may be included as new claims by amendment after filing.

In this document, embodiments of the present disclosure have been mainly described based on a signal transmission/reception relationship between a terminal and a base station. Such a transmission/reception relationship is extended in the same/similar manner to signal transmission/reception between a terminal and a relay or a base station and a relay. A specific operation described as being performed by a base station in this document may be performed by its upper node in some cases. That is, it is obvious that various operations performed for communication with a terminal in a network comprising a plurality of network nodes including a base station may be performed by the base station or network nodes other than the base station. The base station may be replaced by terms such as a fixed station, a Node B, an eNode B (eNB), an access point, and the like. In addition, the terminal may be replaced with terms such as User Equipment (UE), Mobile Station (MS), Mobile Subscriber Station (MSS).

In a hardware configuration, the embodiments of the present disclosure may be achieved by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

In a firmware or software configuration, a method according to embodiments of the present disclosure may be implemented in the form of a module, a procedure, a function, etc. Software code may be stored in a memory unit and executed by a processor. The memory unit is located at the interior or exterior of the processor and may transmit and receive data to and from the processor via various known means

[symbol]

As described before, a detailed description has been given of preferred embodiments of the present disclosure so that those skilled in the art may implement and perform the present disclosure. While reference has been made above to the preferred embodiments of the present disclosure, those skilled in the art will understand that various modifications and alterations may be made to the present disclosure within the scope of the present disclosure.

### INDUSTRIAL AVAILABILITY

The above-described embodiments of the present disclosure are applicable to various mobile communication systems.

1. A method of determining transmission power of an uplink (UL) signal related to NTN (non-terrestrial network) by a user equipment (UE) in a wireless communication system, the method comprising:
receiving configuration information related to power control of the UL signal;
determining the transmission power of the UL signal based on the configuration information; and
transmitting the UL signal based on the transmission power,
wherein the UL signal includes a Physical Uplink Shared Channel (PUSCH) or a Physical Uplink Control Channel (PUCCH),
wherein the configuration information includes a plurality of power control configurations for the NTN, and
wherein the transmission power is determined based on a first power control configuration corresponding to satellite orbit information related to the NTN among the plurality of power control configurations.

2. The method of claim 1, wherein the configuration information further includes the satellite orbit information and information on locations of a platform related to the NTN corresponding to the plurality of power control configurations.

3. The method of claim 2, wherein the first power control configuration is determined as a power control configuration corresponding to the location of the platform related to the NTN estimated based on the satellite orbit information among the plurality of power control configurations.

4. The method of claim 3, wherein the UE determines whether to change the first power control configuration to a second power control configuration among the plurality of power control configurations based on a change of the platform related to the NTN.

5. The method of claim 1, wherein the configuration information further includes information on satellite orbit ranges corresponding to the plurality of power control configurations.

6. The method of claim 5, wherein the UE determines a satellite orbit range corresponding to the platform related to the NTN among the satellite orbit ranges based on the satellite orbit information, and
wherein the first power control configuration is determined as a power control configuration corresponding to the satellite orbit range among the plurality of power control configurations.

7. The method of claim 5, wherein, when a satellite orbit range corresponding to the platform related to the NTN is changed, the first power control configuration is changed to a second power control configuration corresponding to the changed satellite orbit range, and
wherein the transmission power is determined based on the second power control configuration.

8. The method of claim 1, wherein the configuration information further includes information on times at which each of the plurality of power control configurations is sequentially applied.

9. The method of claim 1, wherein the plurality of power control configurations are pre-mapped to a plurality of BWP indexes, and
wherein the UE performs BWP switching with a BWP index corresponding to the first power control configuration.

10. A method of controlling transmission power of a user equipment (UE) by a non-terrestrial network (NTN) in a wireless communication system, the method comprising:
determining a plurality of power control configurations related to power control of an uplink (UL) signal;
transmitting configuration information on the plurality of power control configurations to the UE; and
receiving the UL signal based on the configuration information,
wherein the UL signal includes a Physical Uplink Shared Channel (PUSCH) or a Physical Uplink Control Channel (PUCCH),
wherein the plurality of power control configurations for the NTN are configured based on satellite information of the NTN; and
wherein location information on the corresponding NTN is pre-configured for each of the plurality of power control configurations.

11. The method of claim 10, wherein the configuration information further includes information on satellite orbit ranges corresponding to the plurality of power control configurations, respectively.

12. A user equipment (UE) for determining transmission power of an uplink (UL) signal related to a NTN (non-terrestrial network) in a wireless communication system, the UE comprising:
a radio frequency (RF) transceiver; and
a processor connected to the RF transceiver,
wherein the processor is configured to control the RF transceiver to receive configuration information related to power control of the UL signal, determine a first power control configuration among a plurality of power control configurations related to the NTN based on satellite orbit information for the NTN, determine the transmission power based on the first power control configuration, and control the RF transceiver to transmit the UL signal based on the transmission power,
wherein the UL signal includes a Physical Uplink Shared Channel (PUSCH) or a Physical Uplink Control Channel (PUCCH).

13-15. (canceled)
